(19) United States
(12) Patent Application Publication
(10) Pub. No.: US 2023/0111985 A1
(43) Pub. Date: Apr. 13, 2023

(54) LOW PROFILE AUTO-DIMMING INTERIOR REARVIEW MIRROR ASSEMBLY

(71) Applicant: Magna Mirrors of America, Inc., Holland, MI (US)

(72) Inventor: Matthew V. Steffes, Grand Rapids, MI (US)

(21) Appl. No.: 18/045,487

(22) Filed: Oct. 11, 2022

Related U.S. Application Data
(60) Provisional application No. 63/366,074, filed on Jun. 9, 2022.
(60) Provisional application No. 63/262,402, filed on Oct. 12, 2021.

(51) Int. Cl. B60R 1/08; G02F 1/163

(52) U.S. Cl. CPC B60R 1/088; G02F 1/163; B60R 2011/0033

(57) ABSTRACT

A vehicular interior rearview mirror assembly includes a mounting base having a socket, and a mirror head attached at and pivotable about the mounting base. The mirror head includes a variable reflectance electro-optic mirror reflective element, and a ball member that forms a pivot joint with the socket. The mirror reflective element is attached at an attachment plate that includes electrically conductive elements that are electrically connected to respective electrically conductive contacts at the rear side of the mirror reflective element via a connector portion of each electrically conductive element engaging and flexing and being biased toward the respective electrically conductive contact. The electrically conductive elements are electrically connected to a connector of the ball member. With the mounting base mounted at the interior portion of the vehicle and the ball member received in the socket of the mounting base, the connector is electrically connected to a vehicle wire harness.

### CROSS REFERENCE TO RELATED APPLICATIONS

The present application claims the filing benefits of U.S. provisional application Ser. No. 63/366,074, filed Jun. 9, 2022, and U.S. provisional application Ser. No. 63/262,402, filed Oct. 12, 2021, which are hereby incorporated herein by reference in their entireties.

### FIELD OF THE INVENTION

The present invention relates generally to the field of interior rearview mirror assemblies for vehicles.

### BACKGROUND OF THE INVENTION

It is known to provide a mirror assembly that is adjustably mounted to an interior portion of a vehicle, such as via a double ball pivot or joint mounting configuration where the mirror casing and reflective element are adjusted relative to the interior portion of a vehicle by pivotal movement about the double ball pivot configuration. The mirror casing and reflective element are pivotable about either or both of the ball pivot joints by a user that is adjusting a rearward field of view of the reflective element.

### SUMMARY OF THE INVENTION

An interior rearview mirror assembly provides a slim or reduced thickness mirror head. The interior rearview mirror assembly includes mounting structure mounted at an interior portion of a vehicle and a mirror head adjustably mounted at the mounting structure. The mirror head includes a mirror casing and a mirror reflective element. The mirror reflective element may comprise an electrically variable reflectance mirror reflective element, such as an electro-optic (such as electrochromic) variable reflectance mirror reflective element, where reflectance of the mirror reflective element is controlled via electrical current to the mirror reflective element. Reflectance of the mirror reflective element may be controlled by electrical components disposed remote from the interior rearview mirror assembly. Electrical connection to the mirror assembly may be made through an electrical connector routed through mounting structure of the interior rearview mirror assembly. The mirror head may include an attachment plate with electrically conductive elements that electrically connect to the variable reflectance mirror reflective element and the electrically conductive elements may electrically connect to the electrical connector at the mounting structure.

For example, a vehicular interior rearview mirror assembly provides a mounting base configured to mount at an interior portion of a vehicle equipped with the vehicular interior rearview mirror assembly. The mounting base includes a socket. A mirror head, with the mounting base mounted at the interior portion of the vehicle, is configured to pivotally attach at the mounting base. The mirror head includes a mirror casing and a mirror reflective element. The mirror head includes a ball member that, with the mounting base mounted at the interior portion of the vehicle, is received in the socket of the mounting base to pivotally attach the mirror head at the mounting base. The mirror reflective element includes a variable reflectance electro-optic mirror reflective element. The mirror reflective element is attached at an attachment plate. The attachment plate includes electrically conductive elements. Respective connector portions of each of the electrically conductive elements electrically connect to the mirror reflective element. The electrically conductive elements are electrically connected to a connection feature of the ball member so that with the mounting base mounted at the interior portion of the vehicle and the ball member received in the socket of the mounting base, the connection feature is electrically connected to a power source of the vehicle to electrically power the variable reflectance electro-optic mirror reflective element.

Optionally, the ball member may be integrated into the mirror casing (e.g., the ball member may be formed, such as via an injection molding process, and then the mirror casing may be overmolded, such as via a second injection molding process, over a base portion of the ball member to form a one piece mirror casing and ball member construction). Optionally, the attachment plate may be integrally formed with or form a part of the mirror casing (such as an inner surface of the mirror casing). Optionally, the electrically conductive elements may be disposed within and along a frame portion that attaches (e.g., snap attaches) to the attachment plate.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly;

FIGS. 2 and 3 are front and rear views, respectively, of the interior rearview mirror assembly;

FIG. 4 is a side view of the interior rearview mirror assembly;

FIG. 5 is a perspective view of the interior rearview mirror assembly;

FIG. 6 is an exploded perspective view of the interior rearview mirror assembly;

FIG. 7 is a plan view of a rear side of the mirror reflective element of the interior rearview mirror assembly;

FIG. 8 a is a perspective view of the interior rearview mirror assembly with the mirror reflective element removed to show electrical connectors disposed at respective electrically conductive tabs;

FIGS. 8A and 8B are enlarged partial views of Area VIII in FIG. 8 showing the connection between a connector portion of an electrical connector and an electrically conductive contact at the mirror reflective element;

FIG. 9 is a plan view of the mirror casing of the interior rearview mirror assembly;

FIG. 10 is an enlarged perspective view of the ball member of the mounting structure of the interior rearview mirror assembly;

FIG. 10A is a sectional view of the ball member, taken along the line A-A of FIG. 10;

FIG. 11 is an enlarged view of mounting structure of the interior rearview mirror assembly;

FIGS. 12-15 are different views of the mounting stay and socket of the interior rearview mirror assembly;

FIGS. 16A-16F are enlarged views of the mounting structure of the interior rearview mirror assembly where, in each view, the stay is positioned differently relative to the ball member of the mounting structure;

FIG. 17 is a plan view of an electrical connector that snap attaches to an attachment plate portion of an interior rearview mirror assembly;

FIG. 18 is an enlarged perspective view of the connector portion of the electrical connector of FIG. 17;

FIG. 19 is a perspective view of the electrical connector of FIG. 17;

FIG. 20 is a perspective view of the electrical connector of FIG. 17 with the frame portion removed;

FIGS. 21 and 22 are plan views of a one-piece mirror casing that is overmolded over a ball member;

FIGS. 23 and 24 are enlarged views of the ball member;

FIG. 25 is a perspective view of the ball member received in the socket of a mirror stay;

FIGS. 26-28 are perspective views of the mirror stay;

FIG. 29 is a perspective view of two portions of a mirror stay cover;

FIGS. 30 and 31 are perspective views of the electrical connector being attached to the one-piece mirror casing with integrated ball member;

FIGS. 32-34 are perspective views of the ball member of the mirror casing being received at the socket of the mirror stay, with the electrical connector received at the mirror casing;

FIGS. 35-37 are perspective views of an adhesive element being attached to a mirror reflective element so that apertures of the adhesive element align with electrical tabs at the mirror reflective element;

FIGS. 38 and 39 are perspective views of the one-piece mirror casing, with electrical connector disposed thereat, being attached to the mirror reflective element via the adhesive element;

FIGS. 40 and 41 are perspective views of a connector feature being attached to the end of the electrical connector at a passageway through the ball member;

FIGS. 42-46 are views of the mirror assembly of FIGS. 30-41;

FIG. 47 is an exploded view of the mirror assembly of FIGS. 30-46;

FIG. 48 is a plan view of the mirror reflective element;

FIG. 49 is a perspective view of the mirror assembly of FIGS. 30-46, with the mirror reflective element removed to show electrical connectors attached at the mirror casing;

FIGS. 50 and 51 are enlarged views of the electrical connectors of FIG. 49;

FIG. 52 is an enlarged view of the overmolded ball member;

FIG. 52A is a sectional view taken along the line A-A of FIG. 52;

FIG. 53 is an enlarged view of the mounting structure of the interior rearview mirror assembly;

FIGS. 54-56 are different views of the mounting stay and socket of the interior rearview mirror assembly;

FIGS. 57A-57F are enlarged views of the mounting structure of the interior rearview mirror assembly where, in each view, the stay is positioned differently relative to the ball member of the mounting structure;

FIG. 58 is a plan view of a housing cap that attaches to a rear surface of the attachment place to form the mirror housing of the interior rearview mirror assembly;

FIG. 59 is a plan view of the attachment plate that receives the housing cap;

FIG. 60 is a perspective view of the mirror housing; and

FIG. 61 is an exploded view of the mirror housing of FIG. 60.

### DESCRIPTION OF THE PREFERRED EMBODIMENTS

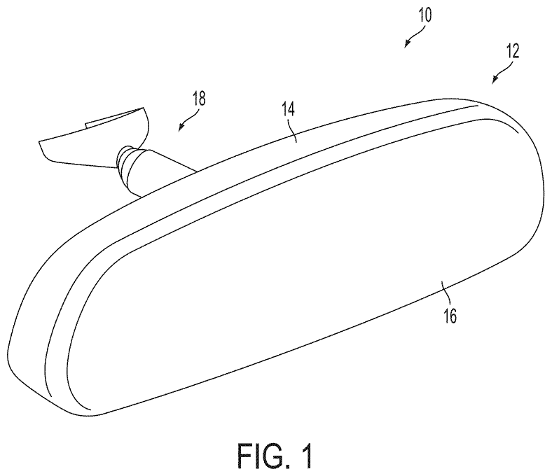

Referring now to the drawings and the illustrative embodiments depicted therein, an interior rearview mirror assembly 10 for a vehicle includes a mirror head 12 having a casing 14 and a reflective element 16 positioned at a front portion of the casing 14 (FIG. 1). In the illustrated example, the mirror assembly 10 is configured to be adjustably mounted to an interior portion of a vehicle (such as to an interior or in-cabin surface of a vehicle windshield or a headliner of the vehicle or the like) via a mounting base or mounting structure or mounting configuration or assembly 18. The mirror reflective element comprises a variable reflectance mirror reflective element that varies its reflectance responsive to electrical current applied to electrically conductive coatings or films or layers of the reflective element. As discussed below, the mirror assembly provides a thin or substantially reduced size or reduced profile mirror head with an auto-dimming mirror reflective element that allows for automated assembly of the interior rearview mirror assembly.

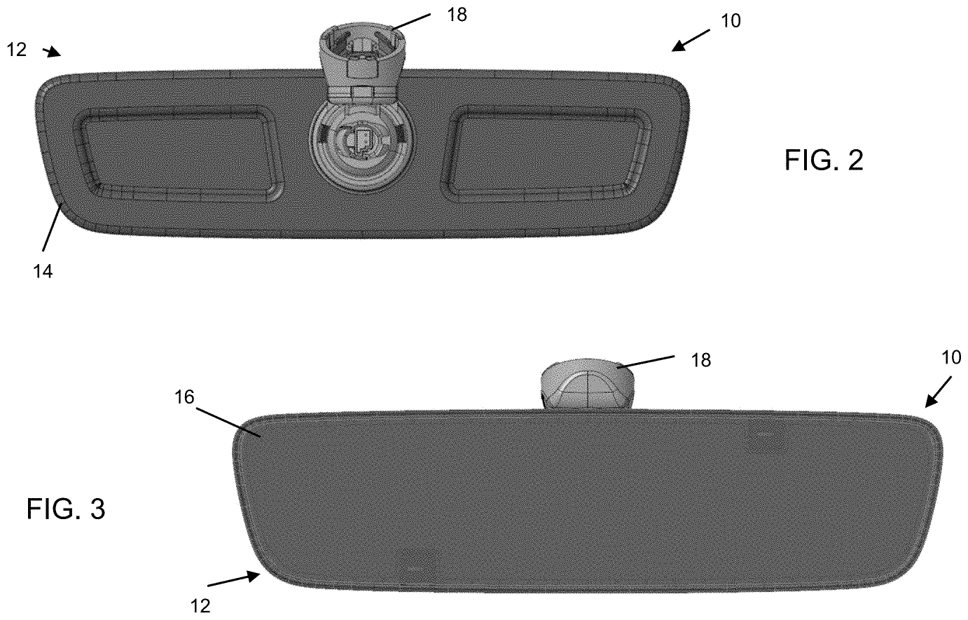

For example, and such as shown in FIGS. 2-5, the mirror head 12 of the mirror assembly 10 has a reduced or minimized housing depth or thickness dimension (the dimension between the front generally planar surface of the reflective element 16 and the rear surface of the mirror casing 14 at a generally central region of the mirror head), such as less than about 20 mm or less than about 15 mm or less than about 10 mm. For example, the mirror head 12 may have a thickness of 10.3 mm. Optionally, the mirror head 12 may have a thickness of less than 9 mm, such as, for example, 8.6 mm. The mirror casing 14 and reflective element 16 thus may have a thin construction and the casing and reflective element may have radiused or tapered perimeter edge regions.

The mirror reflective element 16 comprises a laminate construction variable reflectance electro-optic (such as electrochromic) mirror reflective element having a front substrate 20, a rear substrate 22, and an electro-optic medium (such as an electrochromic medium) sandwiched therebetween and bounded by a perimeter seal. The front substrate 20 has a front or first surface 20a (the surface that generally faces the driver of a vehicle when the mirror assembly is normally mounted at the vehicle) and a rear or second surface 20b opposite the front surface 20a. The rear substrate 22 has a front or third surface 22a and a rear or fourth surface 22b opposite the front surface 22a, with the electro-optic medium bounded by the perimeter seal of the reflective element. Such an electrochromic glass assembly dims or darkens responsive to electrical current applied to electrically conductive coatings or layers or films disposed at the rear or second surface 20b of the front glass substrate and in contact with the electro-optic medium and disposed at the front or third surface 22a of the rear glass substrate 22 and in contact with the electro-optic medium.

For example, the second surface 20b of the front glass substrate may have a transparent conductive coating established thereat, such as an indium tin oxide (ITO) layer, or a doped tin oxide layer or any other transparent electrically semi-conductive layer or coating or the like (such as indium cerium oxide (ICO), indium tungsten oxide (IWO), or indium oxide (10) layers or the like or a zinc oxide layer or coating, or a zinc oxide coating or the like doped with aluminum or other metallic materials, such as silver or gold or the like, or other oxides doped with a suitable metallic material or the like, or such as disclosed in U.S. Pat. No. 7,274,501, which is hereby incorporated herein by reference in its entirety, while the third surface 22a has a metallic reflector coating (or multiple layers or coatings) established thereat. The front or third surface 22a of rear substrate 22 may include one or more transparent semi-conductive layers (such as an ITO layer or the like), and one or more metallic electrically conductive layers (such as a layer of silver, aluminum, chromium or the like or an alloy thereof), and may include multiple layers such as disclosed in U.S. Pat. Nos. 7,274,501; 7,184,190 and/or 7,255,451, which are hereby incorporated herein by reference in their entireties. The mirror reflector may comprise any suitable coatings or layers, such as a transflective coating or layer (such as described in U.S. Pat. Nos. 7,626,749; 7,274,501; 7,255,451; 7,195,381; 7,184,190; 6,690,268; 5,140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, which are hereby incorporated herein by reference in their entireties) disposed at the front surface 22a of the rear substrate 22 and opposing the electro-optic medium, such as an electrochromic medium disposed between the front and rear substrates and bounded by the perimeter seal (but optionally, the mirror reflector could be disposed at the rear surface 22b of the rear substrate 22).

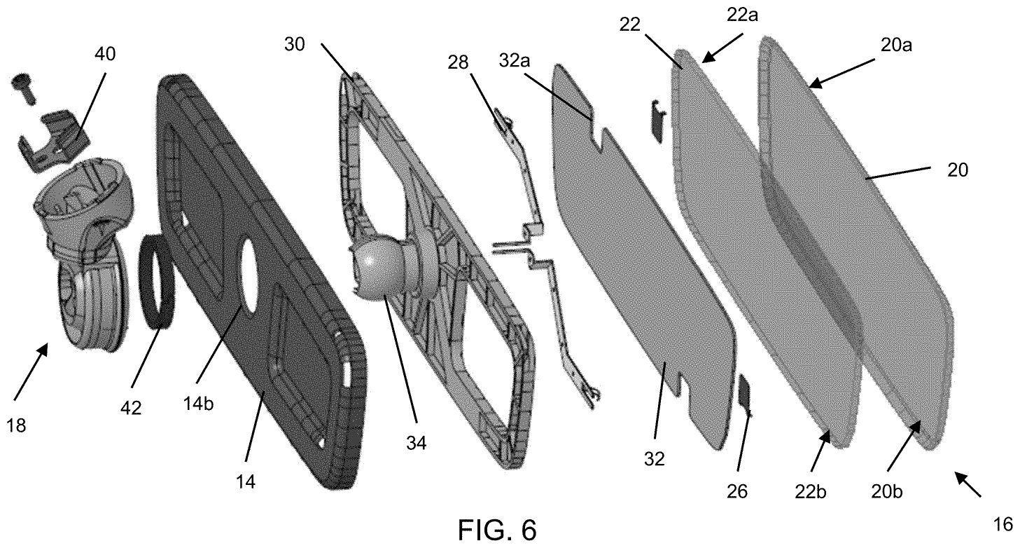

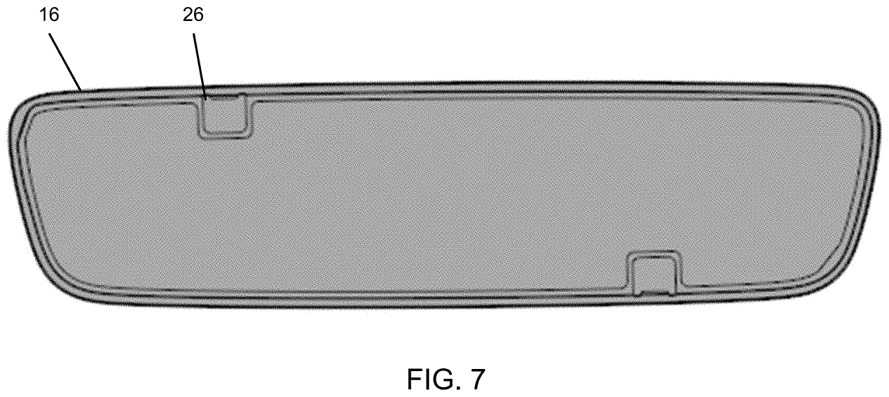

As shown in FIGS. 6-8B, the mirror reflective element 16 includes two electrical connectors or tabs 26 in electrical connection with a respective one of the transparent electrically conductive coating at the second surface 20b of the front glass substrate 20 and the electrically conductive coating at the third surface 22a of the rear glass substrate 22. For example, the electrical connector or tab 26 that electrically connects to the electrically conductive coating at the third surface 22a may be disposed at a wraparound coating or busbar that is electrically conductively connected to the electrically conductive coating at the third surface 22a, while the electrical connector or tab 16 that electrically connects to the electrically conductive coating at the second surface 20b may be disposed at an electrically conductive element (e.g., an electrically conductive epoxy) that is electrically conductively connected to the electrically conductive coating at the second surface 20b and that is electrically isolated from the wraparound coating and the electrically conductive coating at the third surface 22a.

Electrical connectors 28 disposed at and along a mirror attachment plate 30 electrically connect the tabs 26 with a wire harness of the vehicle for electrically powering and controlling the reflectance of the mirror reflective element 16. The mirror attachment plate 30 receives the mirror reflective element 16, such as via an adhesive disposed between the mirror reflective element 16 and the mirror attachment plate 30, to attach the mirror reflective element 16 at the mirror casing 14. Although shown as spaced from one another or at opposing side regions of the mirror reflective element 16, the respective electrical tabs or connectors 26 may both be positioned at a center region of the mirror reflective element 16 in order to simplify the electrical components providing electrical connectivity between the electrical connectors or tabs 26 and the electrical connectors 28.

Reflectance of the mirror reflective element 16 may be controlled by an electronic control unit (ECU) including electronic circuitry and associated software, such as responsive to signals from a sensor at the vehicle. For example, the vehicle may include an ambient light sensor and a glare light sensor or the reflectance may be controlled responsive to processing of image data at an image processor of the ECU, where the image data is captured by a camera at the vehicle (such as by a rearward viewing camera of the vehicle). The electrical components controlling the EC cell, including the printed circuit board (PCB) (such as a PCB that includes the ECU) and sensors, are removed from the mirror head 12 and located outside the mirror head 12 and within the vehicle. For example, the ECU and/or sensor may be disposed at a windshield mounted console or an overhead console mounted at the headliner of the vehicle, or the like. Data transfer or signal communication from the camera to the ECU may comprise any suitable data or communication link, such as a vehicle network bus or the like of the equipped vehicle.

The mirror head thus includes the two electrically conductive metallic stampings 28—power and ground—which connect the electrical connectors or contact pads or tabs 26 at the back of the EC cell to the vehicle-side wire harness connector. Thus, the electrical tabs 26 at the rear or fourth surface 22b of the mirror reflective element 16 are electrically connected to respective electrically conductive elements or electrical connectors 28 of the mirror head that electrically connect to the vehicle wire harness to provide electrical current to the electrically conductive coatings of the mirror reflective element 16 to power and control reflectance of the mirror reflective element 16. As discussed below, the stampings or electrically conductive elements or electrical connectors 28 are integrated into a glass case or the mirror attachment plate 30, and travel through the mounting structure 18 of the mirror assembly.

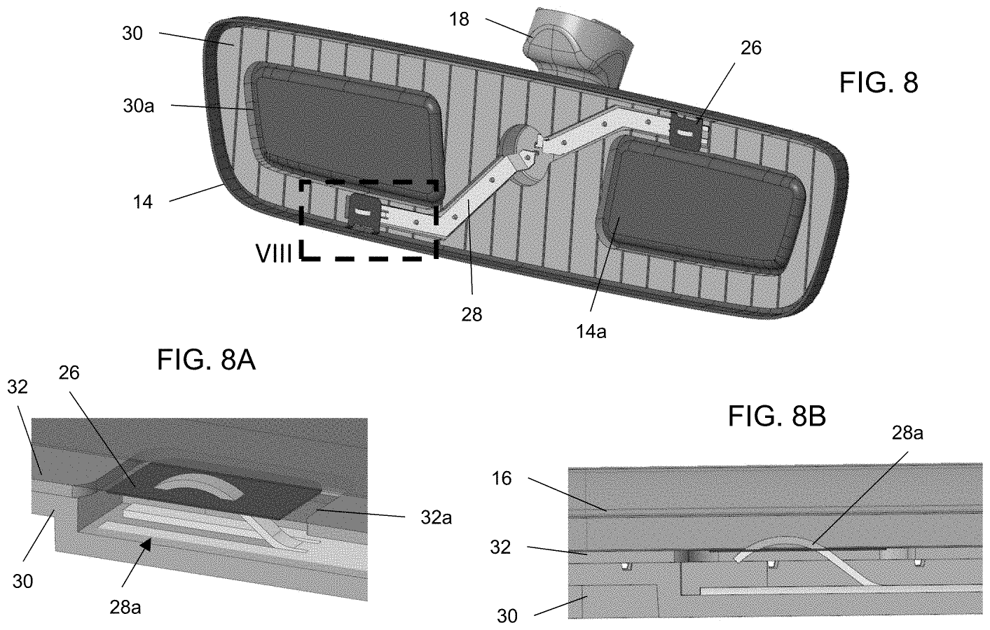

The mirror attachment plate 30 at least partially receives the mirror reflective element 16 and secures the mirror reflective element 16 at the mirror casing 14, such as adhesively securing the mirror reflective element 16 at the mirror casing 14. In the illustrative example, an adhesive element 32, such as a layer of adhesive or foam tape or the like, is disposed between the mirror attachment plate 30 and the mirror reflective element 16 to adhesively retain the mirror reflective element 16 at the mirror attachment plate 30 (FIGS. 6 and 8B). Thus, the foam tape 32 adhesively attaches at a first side to the mirror attachment plate 30 and adhesively attaches at a second side (opposite the first side) to the mirror reflective element 16. As shown in FIG. 8, the mirror attachment plate 30 may include one or more apertures 30a to expose a portion of the mirror casing 14 to the first side of the foam tape 32. Thus, the same adhesive element that secures the mirror reflective element 16 to the attachment plate 30 may secure the attachment plate 30 to the mirror casing 16. Optionally, the mirror casing 14 may include one or more corresponding protrusions or raised portions 14a that protrudes at least partially into the one or more apertures 30a of the mirror attachment plate 30 to engage the first side of the foam tape 32.

As shown in FIGS. 8, 8A, and 8B, the electrical tabs 26 are disposed at the rear surface of the mirror reflective element 16 at cutouts or apertures or notches 32a formed through the adhesive element 32, to provide electrical connection between the conductive layers of the mirror reflective element 16 and electrical connectors 28. The electrical connectors 28 may be integrated into the mirror attachment plate 30 (such as staked in place via a plurality of projections of the attachment plate being received in apertures of the connectors, or the connectors may be insert molded with the attachment plate) to provide a relatively flat or slim electrical connector behind the mirror reflective element 16 within the mirror head 12. Respective connector portions 28a of the connectors 28 may be exposed to the electrical tabs 26 at the mirror reflective element 16 through the cutouts or apertures 32a in the foam tape 32.

The connector portion 28a of the electrical connector 28 engages the electrical tab 26, such as press fitting or snap attaching to the electrical tab 26. In the illustrated example, the connector portion 28a comprises a curved prong or tine that extends above the body of the electrical connector 28, with the body of the electrical connector being substantially flat against the attachment plate 30 (e.g., FIG. 8B). Thus, the curved prong of the connector portion 28a extends from the attachment plate to engage the electrical tab 26. Optionally, the connector portion 28a may be spring loaded or biased toward and into connection with the electrical tab 26, such as to maintain a secure electrical connection between the connector portion 28a and the electrical tab 26. Optionally, the connector portion 28a may comprise a spring-loaded extendable and retractable pin (or pogo pin) (such as by utilizing aspects of the electrical connections described in U.S. Pat. Nos. 10,446,563 and/or 9,878,669, and/or U.S. Publication No. US-2022-0089102, which are hereby incorporated herein by reference in their entireties).

The electrical connector portion may provide duplicate contact points for backup in case of connection failure. The electrical connector portion may also provide a rounded contact pad to reduce damage due to vehicle vibration, such as to the mirror reflective element or electrical connector. Thus, when the mirror reflective element 16 is disposed at the attachment plate 30, such as via adhesive attachment at the foam tape 32, the electrical tabs 26 at the mirror reflective element may align with apertures 32a in the foam tape 32 so that the electrical connector 28 at the attachment plate 30 may electrically connect to the mirror reflective element 16 via the spring-loaded or biased connector portion 28a engaging the electrical tabs 26. Thus, electrical connection of the connector portion to the electrical tabs or clips at the mirror reflective element is made when the mirror reflective element is adhered to the mirror attachment plate via the adhesive foam, and the spring-biasing of the prongs of the connectors maintain engagement and electrical connection with the tabs or clips during use of the mirror assembly on a vehicle.

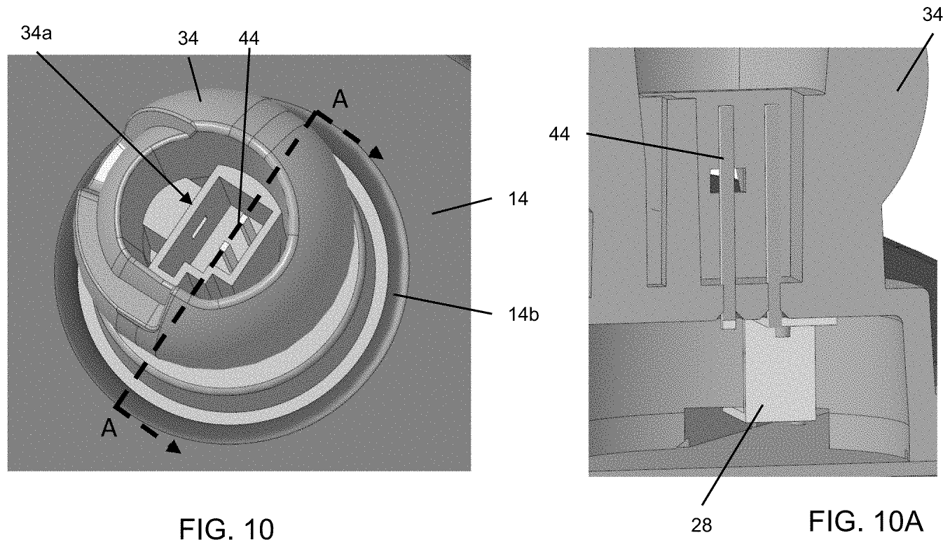

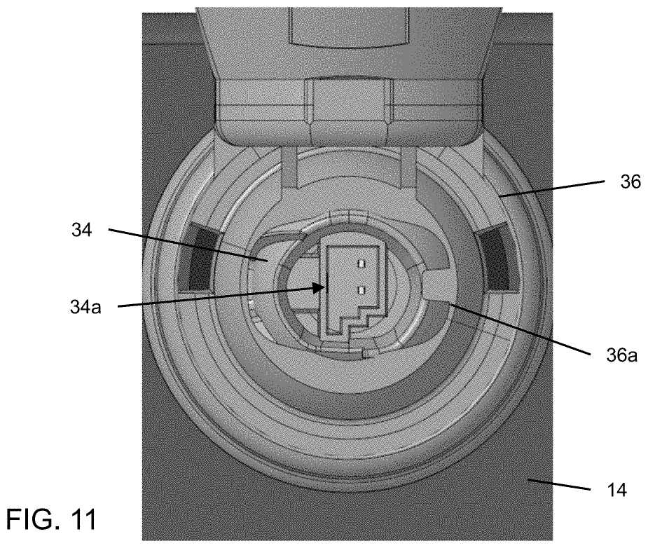

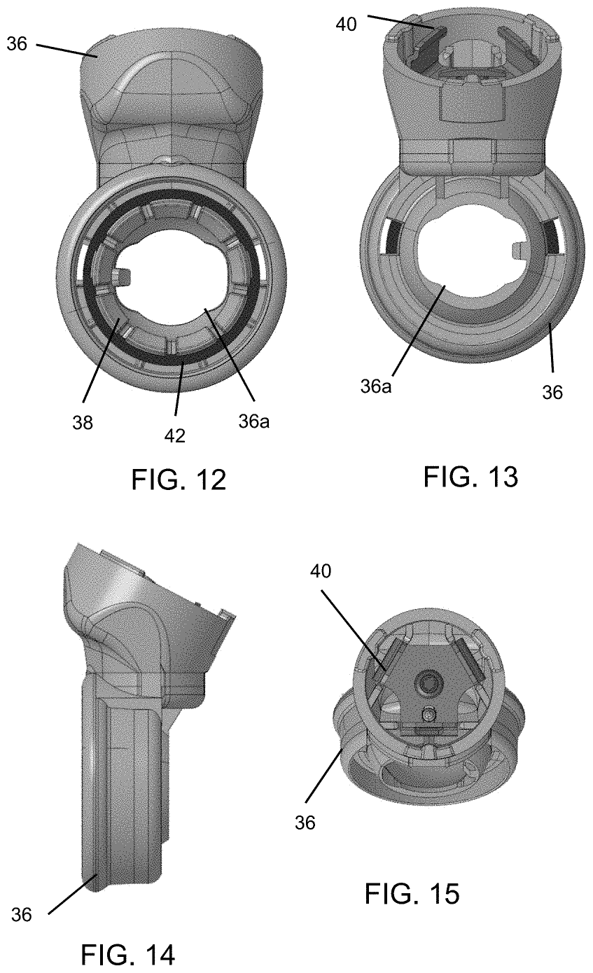

As shown in FIGS. 10-16F, the mounting structure 18 comprises a ball and socket construction, including a ball member 34 that pivotally attaches to a socket 38 of a mounting base or stay 36. The stay 36 may mount at the interior of the vehicle, such as directly to the windshield or headliner or another component (such as an overhead console or windshield mounted console), via any suitable means such as adhesive or a fastener. In the illustrated example, the stay 36 mounts at the vehicle via a spring clip 40 (FIGS. 13 and 15). A socket spring ring 42 (FIG. 12) may circumscribe the socket 38 and provide a retaining force to retain the ball member 34 in the socket 38 when the ball member 34 is disposed thereat. The ball member 34 protrudes or extends from the rear surface of the mirror casing 14 to engage the stay 36 behind the mirror head 12. Thus, the pivot system is reversed from traditional designs, with the ball member 34 as part of the mirror head 12 and the socket 38 as part of the stay 36 or mounting portion of the mounting structure 18. This is done to allow direct access to the electrical connector, no matter what position the mirror head is in. The electrical connectors travel through the inside of the ball and socket pivot system to electrically connect to the wire harness of the vehicle.

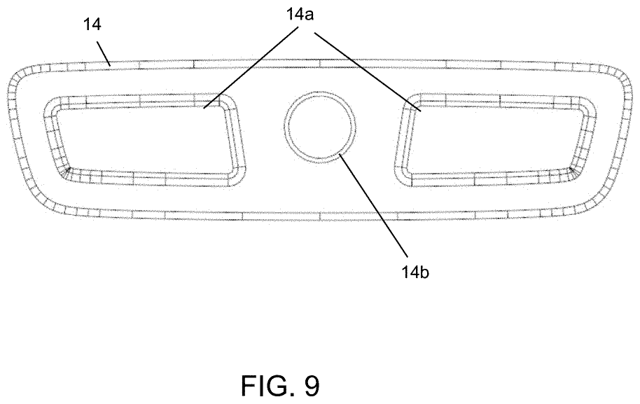

As shown in FIGS. 9-15, the ball member 34 protrudes from the attachment plate 30 and through an aperture 14b of the mirror casing 14 to attach at the socket 38 at the rear of the mirror head 12. The ball member 34 may comprise a metallic or plastic ball member and may be integrally formed with the attachment plate 30 or insert molded with the attachment plate 30. The electrical connectors 28 integrated or disposed at the attachment plate 30 include ends or terminals 44 that electrically connect to or are received in a connector receiver or connector feature 34a of the ball member 34. The connector feature 34a of the ball member 34 is configured to receive or connect to an electrical connector of the vehicle wire harness to electrically connect the electrical connectors 28 to the vehicle wire harness. For example, a portion of the electrical connectors 28 may pass through the ball member 34 to be exposed at the connector feature 34a for electrical connection, or electrical prongs or contacts may be inserted through the ball member 34 and electrically connect the connector feature 34a and the electrical connectors 28.

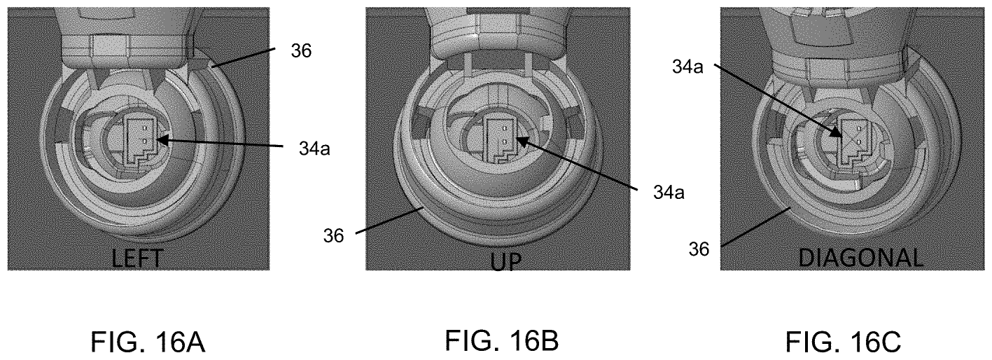

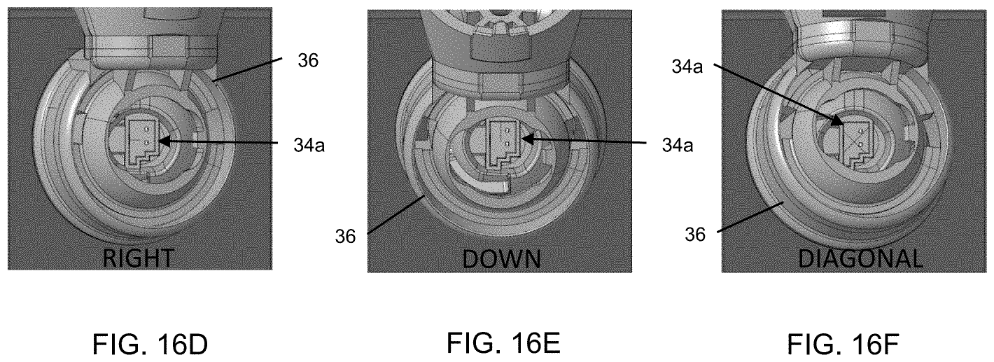

The stay 36 includes an aperture 36a at a rear surface of the socket 38 to enable connection between the vehicle wire harness and the connector feature 34a of the ball member 34. As shown in FIGS. 16A-16F, the aperture 36a of the stay 36 is configured to allow for movement or pivoting of the mirror head 12 (and therefore ball member 34) relative to the stay 36 while maintaining connection between the vehicle wire harness and connector feature 34a. Eliminating the pigtail wire harness connector allows for automated assembly and integrating the connector directly to the ball stud allows for a direct connector insertion in the vehicle. Optionally, a cover piece may be added to the stay 36 to hide the wire harness once it is installed to the vehicle. Snap features can be implemented around the socket to provide attachment points for the cover.

Thus, when the mirror assembly 10 is installed in the vehicle, the stay 36 or portion of the mounting structure including the socket 38 may be mounted at the interior portion of the cabin of the vehicle and the mirror assembly may be attached at the stay 36 by pivotally engaging the ball member 34 with the socket 38. The connector feature 34a of the ball member 34 may be accessible through the aperture 36a in the rear wall of the socket 38 for connecting an electrical connector of the vehicle wire harness thereat to electrically connect the mirror assembly 10 to the vehicle wire harness. Electrical current for controlling the reflectance of the electro-optic reflective element is thus run through wiring passing through the mounting structure and electrical connectors integrated in the mirror attachment plate, with the electrical components (e.g., EC dimming control circuitry) controlling the reflectance located remote from the mirror head to provide a slim or reduced profile mirror head.

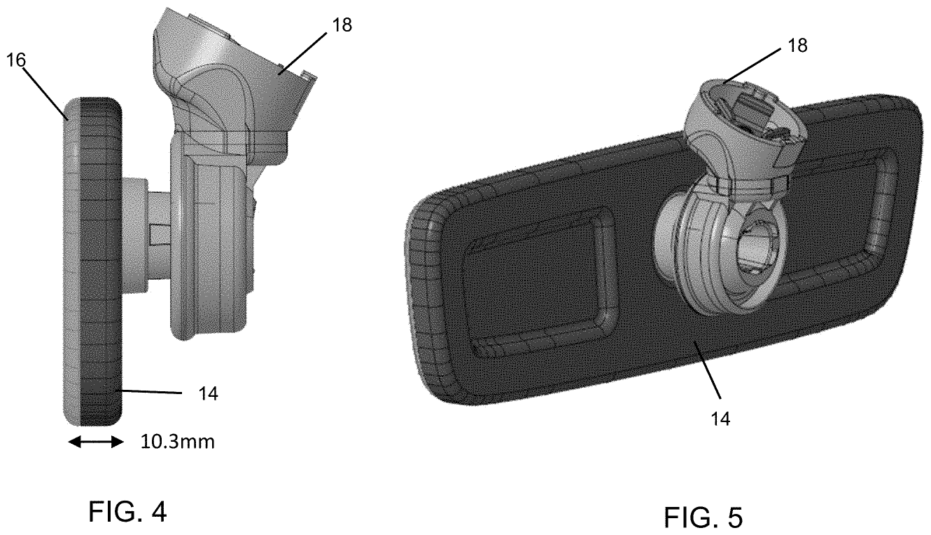

The mirror casing 14 may be made of any suitable material, such as plastic or stamped aluminum. The surface of the mirror casing 14 may be brushed, painted, film (such as hydro dipping). As shown in FIG. 4, the mirror casing 14 partially receives the mirror reflective element 16 therein, such that a perimeter portion of the casing circumscribes the rear glass substrate of the electro-optic reflective element, with the front glass substrate having a rounded or curved perimeter edge to provide a rounded transition from a planar front or first surface of the reflective element to a side surface of the housing. The styling of the mirror casing 14 can produce a thinner edge appearance. For example, compared to a traditional interior rearview mirror, the front glass thickness may decrease, such as from about 3.2 mm to 2.3 mm. The mirror casing may taper out to the glass edge rather than approach at a straight angle. Optionally, the casing may extend over and circumscribe the perimeter edge of the front substrate, whereby the housing may provide a rounded or curved perimeter region to provide a rounded transition from the planar front or first surface of the reflective element to the side surface of the casing. Thus, the mirror assembly provides curved edges of the mirror reflective element and maintains a consistent gap around the edge at the second or rear surface of the front substrate.

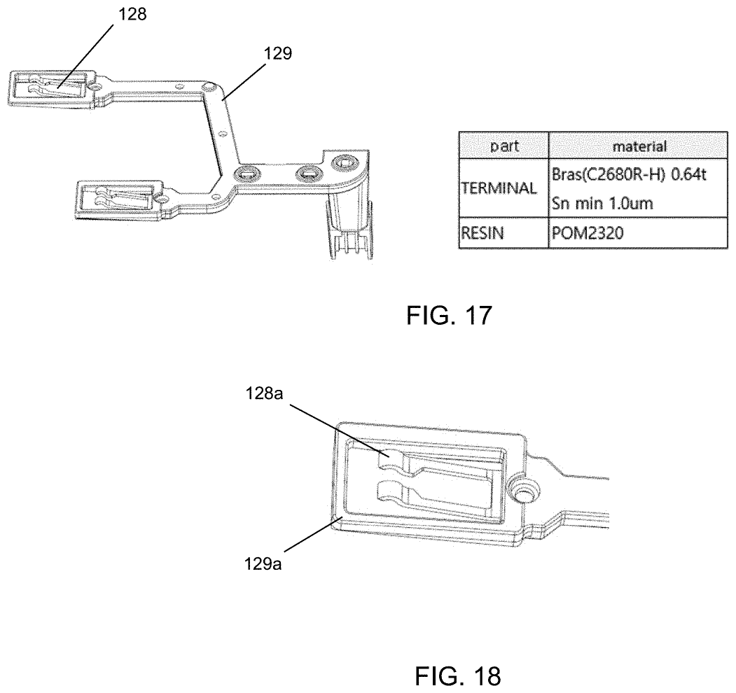

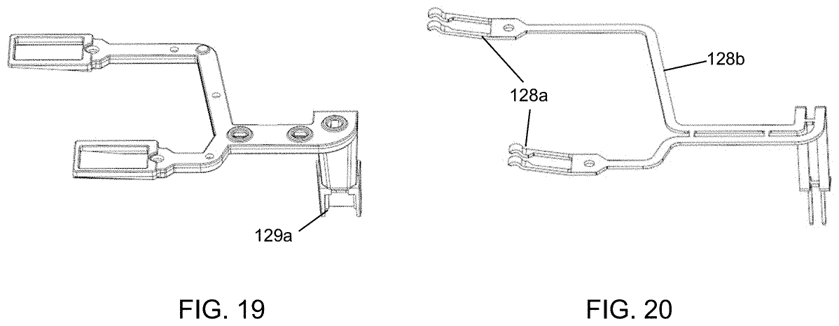

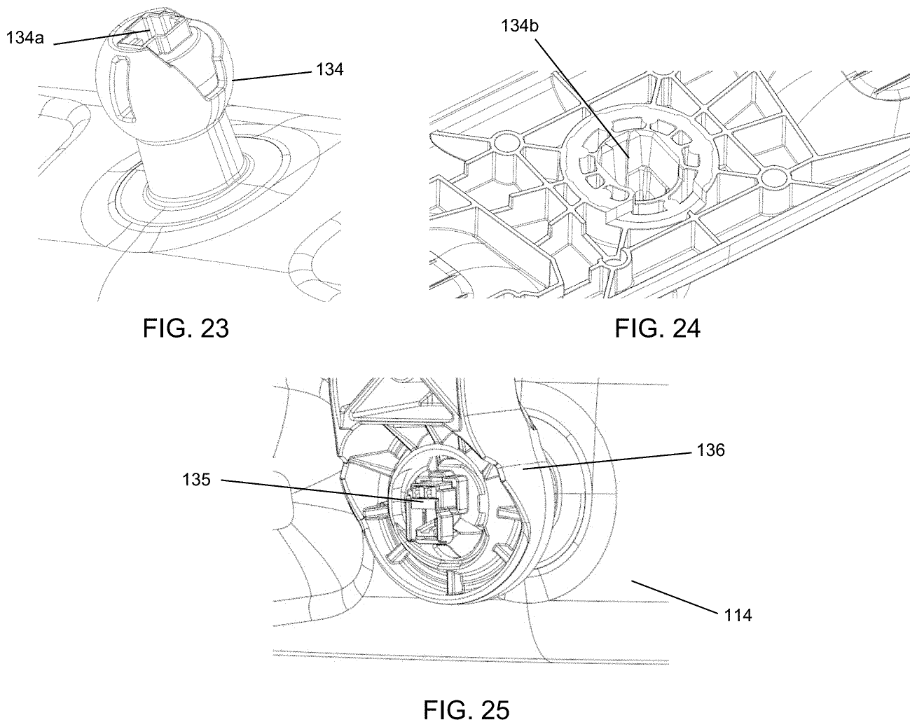

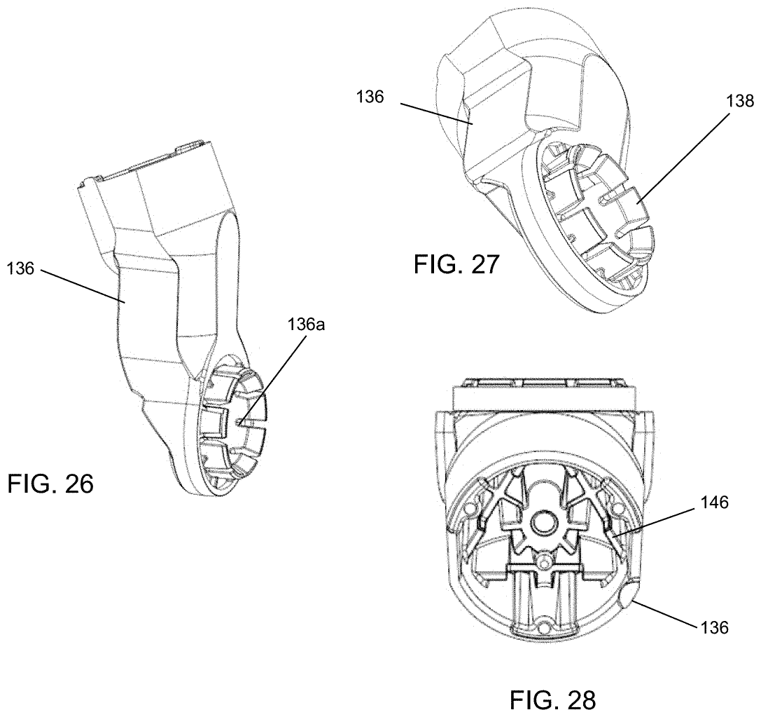

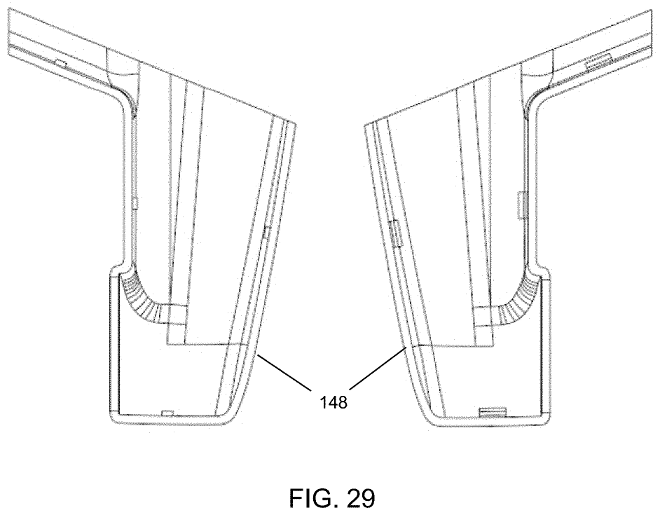

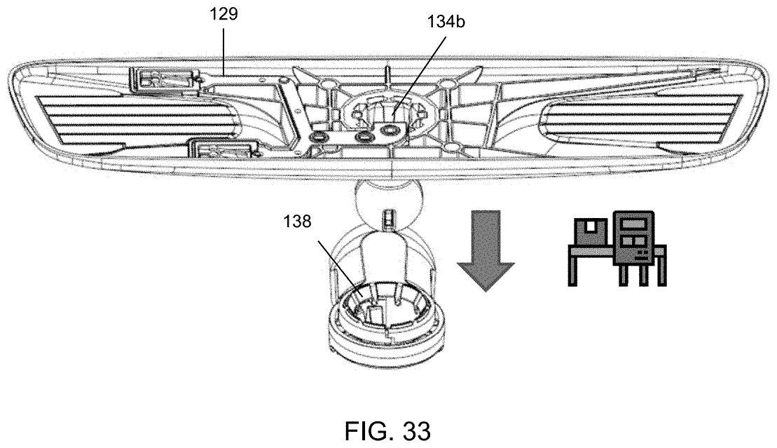

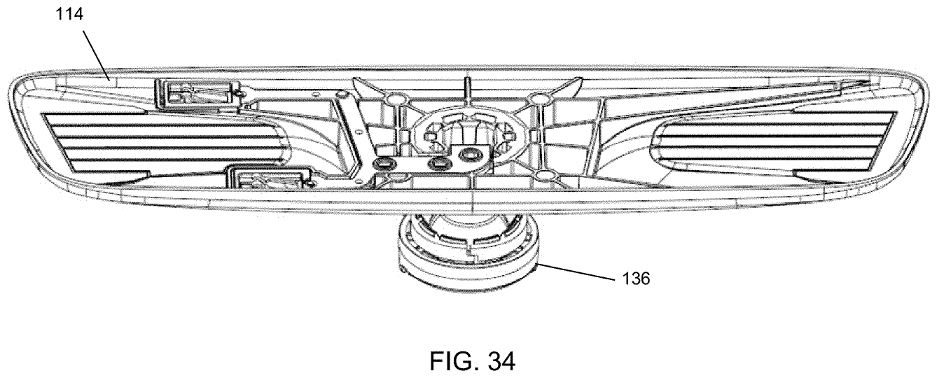

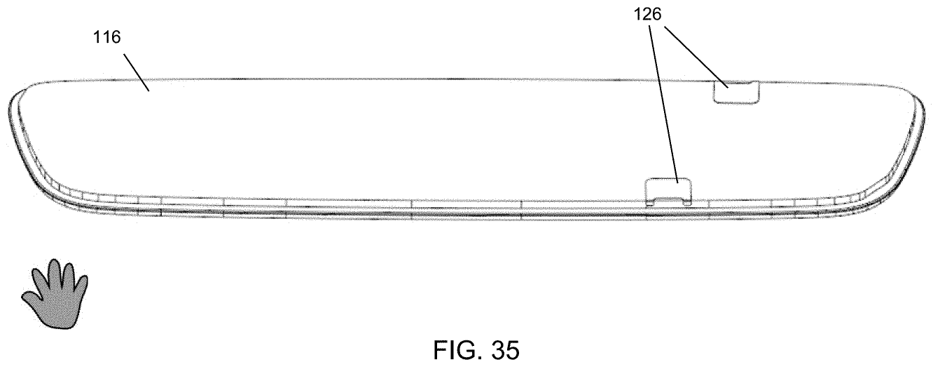

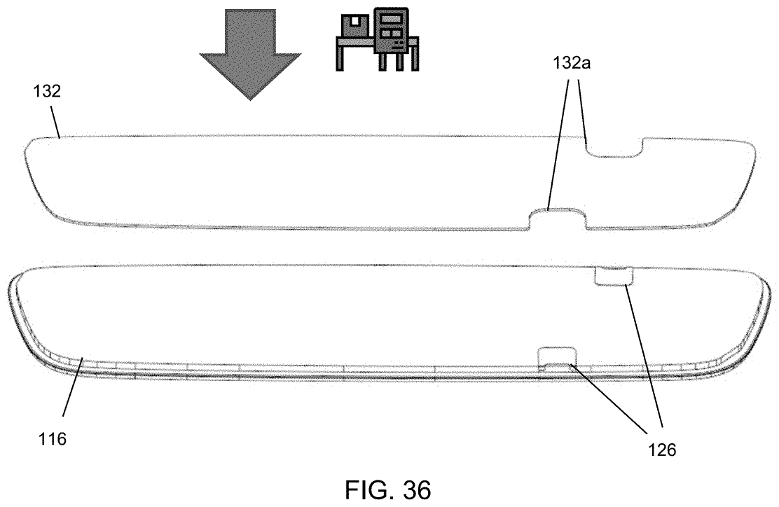

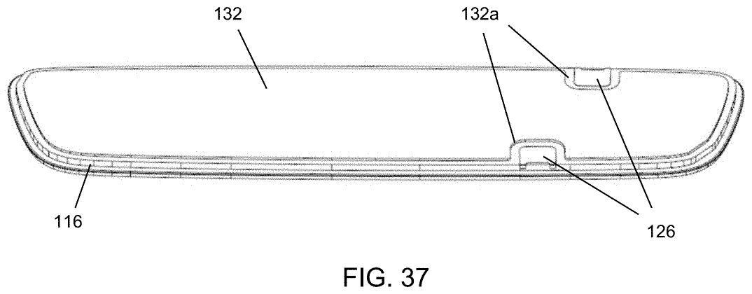

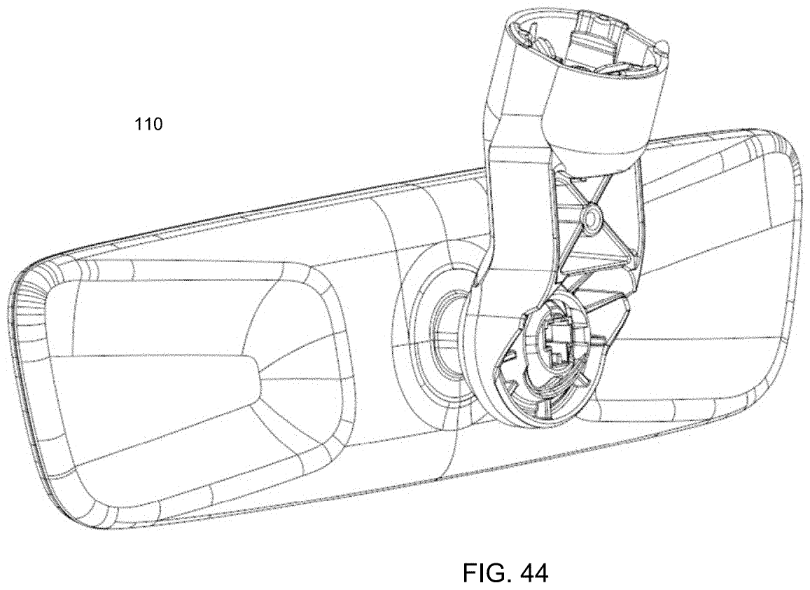

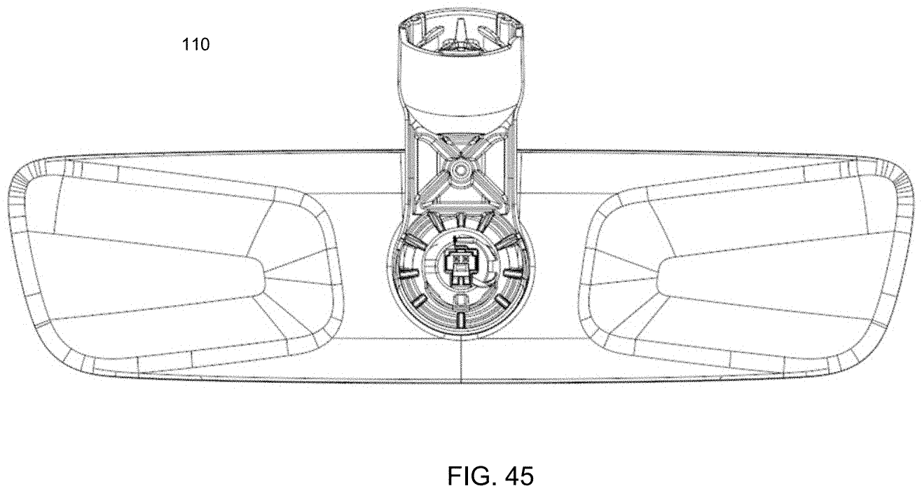

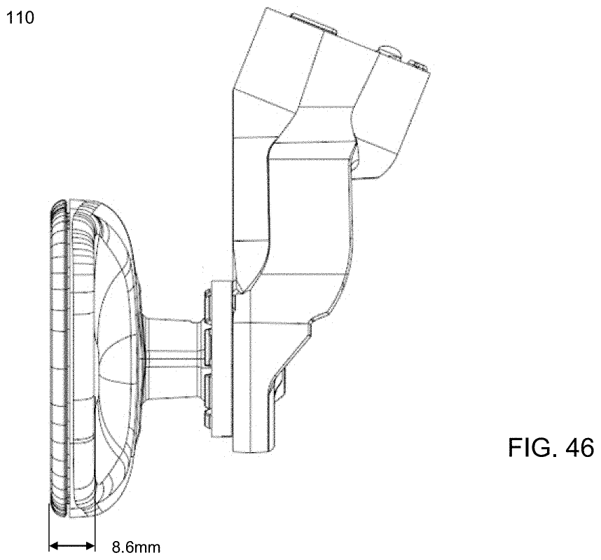

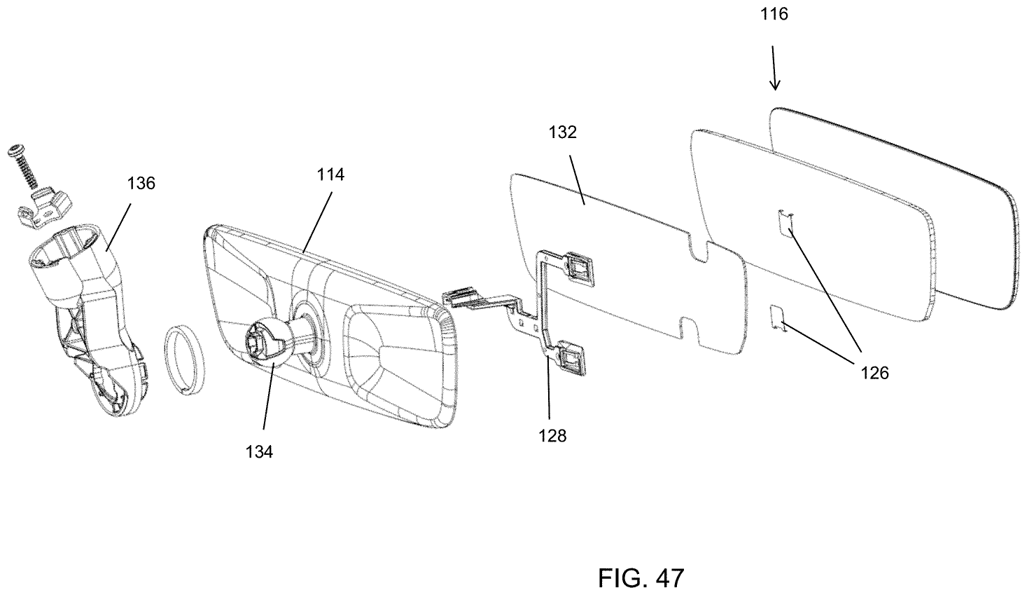

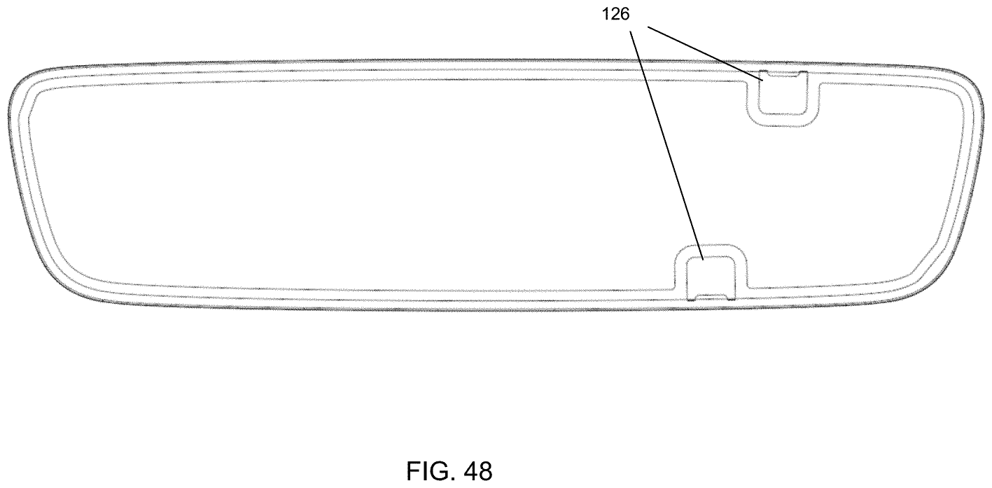

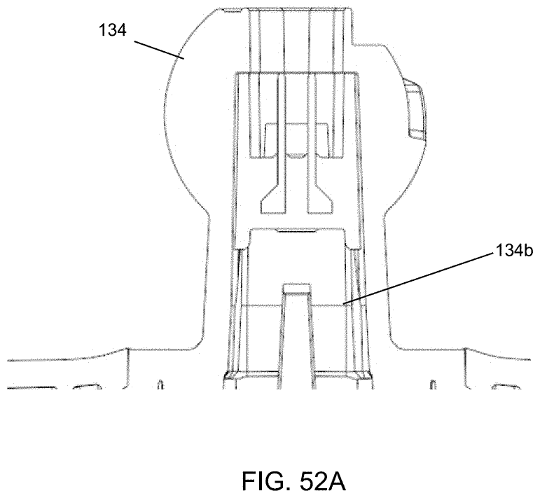

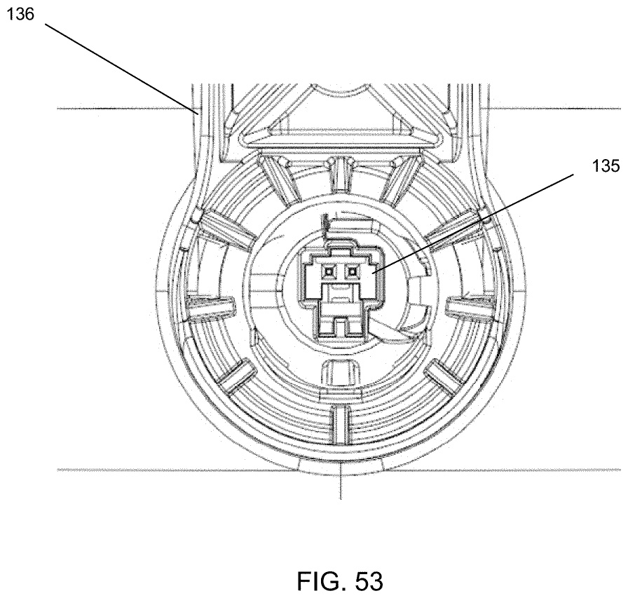

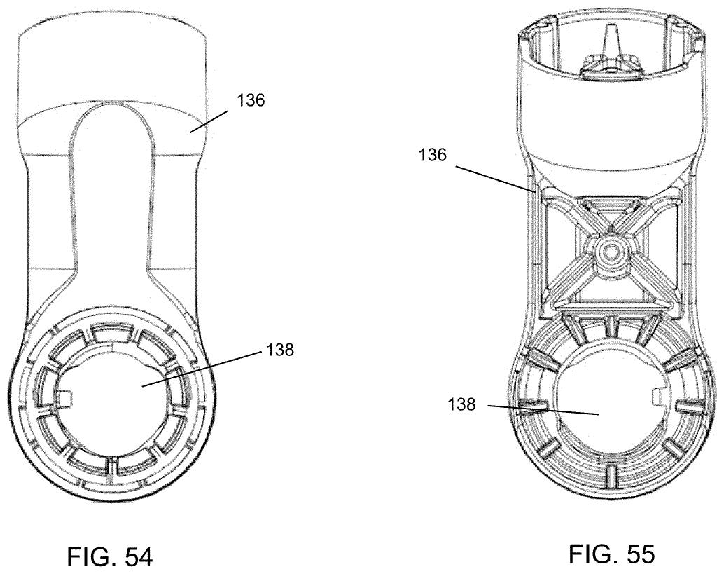

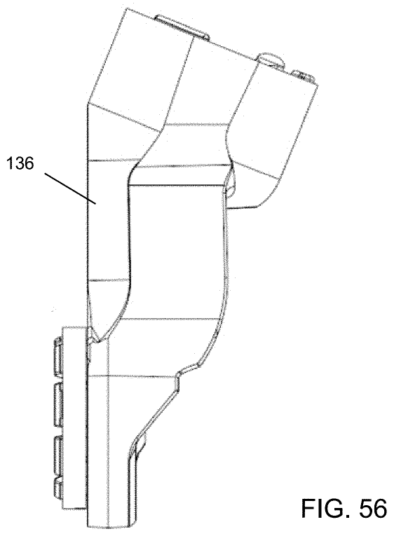

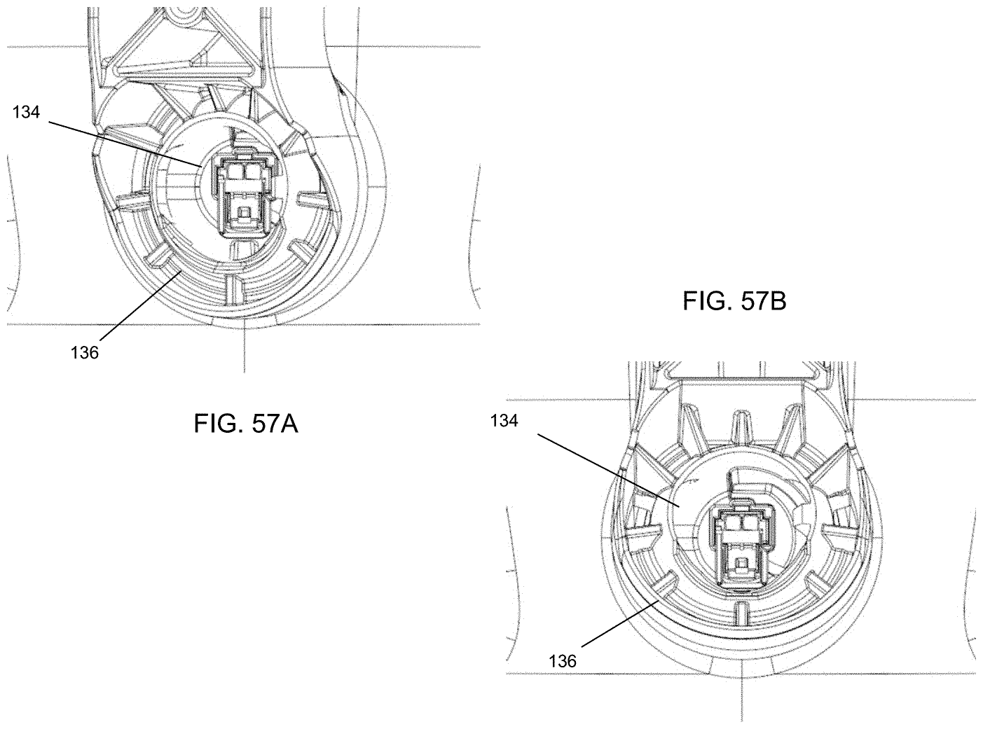

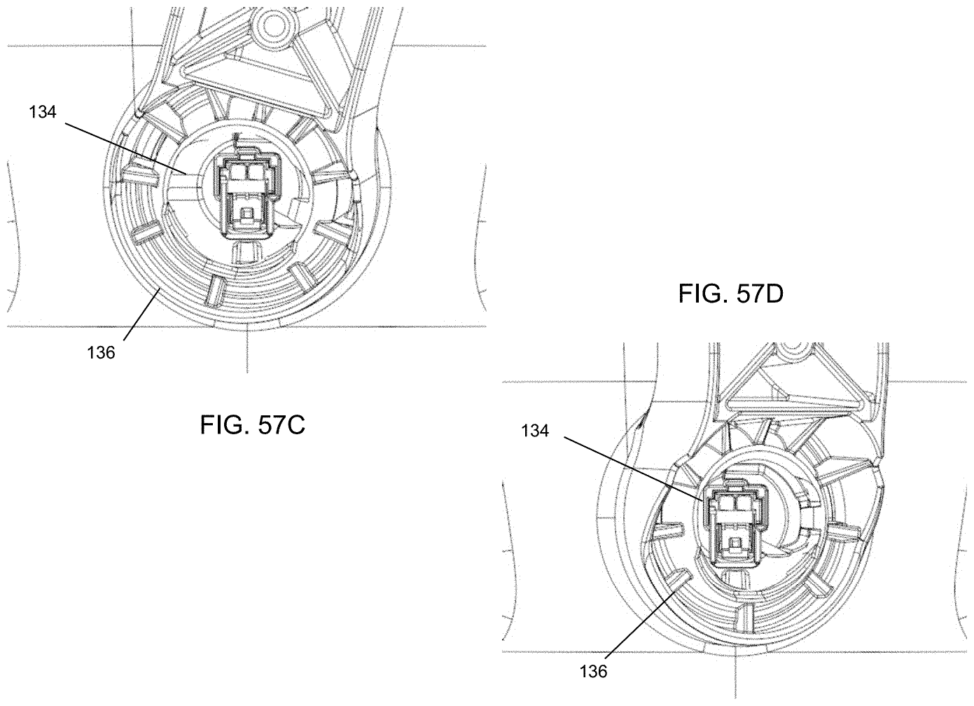

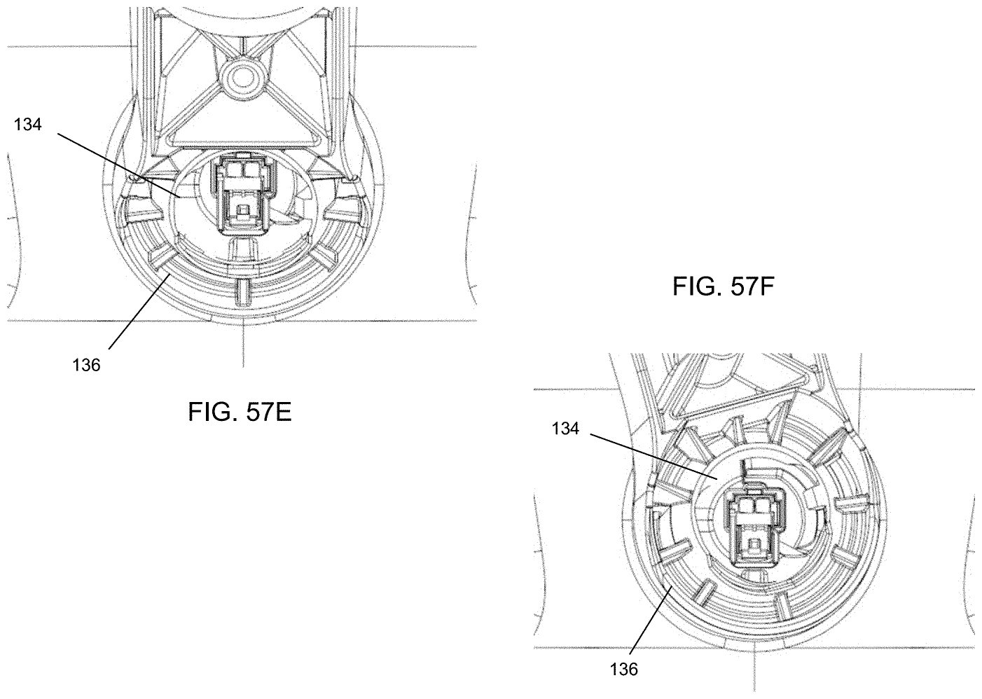

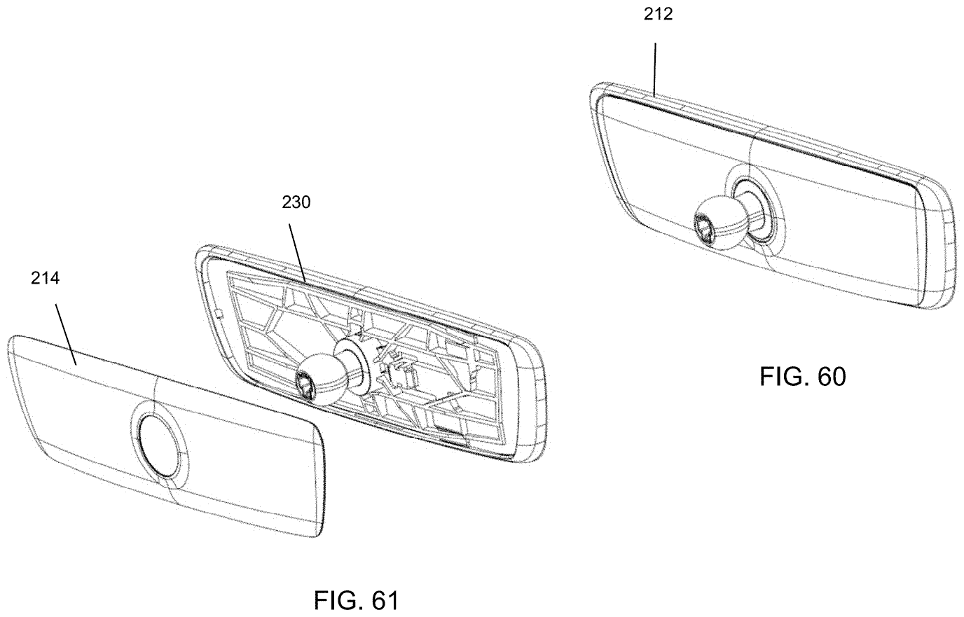

Referring now to FIGS. 17-62, a mirror assembly 110 includes a one-piece mirror casing 114 overmolded over the ball member 134 and an electrical connector 128 that connects to the inner surface of the mirror casing 114, such as via snap attaching or press fitting, for alignment with electrical tabs 126 (e.g., FIGS. 35 and 48) at the mirror reflective element 116 when the mirror reflective element 116 is received at and adhered at or attached at the mirror casing 114.

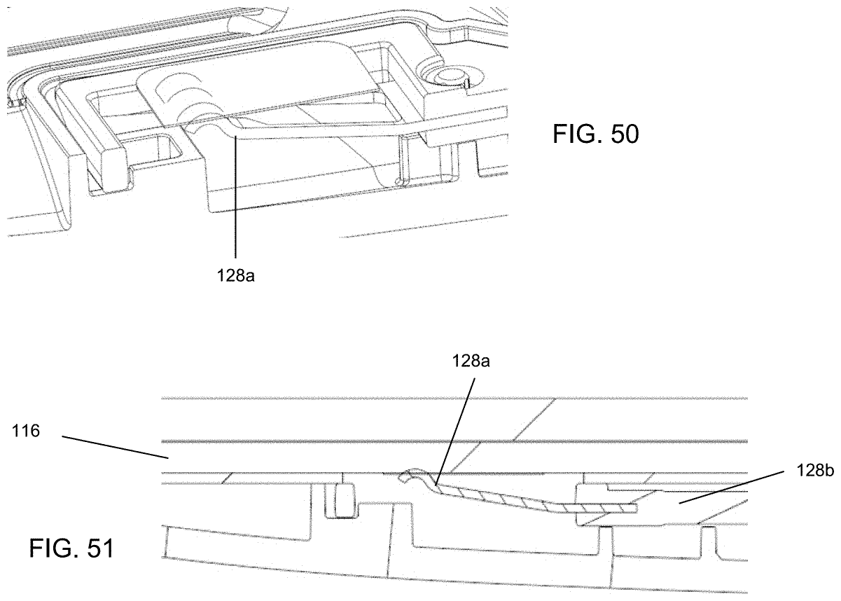

As shown in FIGS. 17-20, electrical connector 128 includes electrical connector portions 128a that engage the electrical tabs 126 when aligned with the tabs 126 at the rear surface of the mirror reflective element 116. The connector portions 128a are electrically connected to (such as integrally formed with) respective electrical terminal or conductor portions 128b, where the conductor portions 128b are electrically connected to the connector portions 128a at a first end and electrically connected to a connector feature or element 135 (discussed below) at a second end for connection to the vehicle wire harness. The connector portions 128a may be bent or curved or angled relative to the conductor portions 128b so that, with the connector portions 128a aligned and engaged with the tabs 126, the connector portions 128a may be biased into engagement with the tabs 126. In the illustrated example, the connector portions 128a each include two spring fingers extending from the conductor portion 128b of the connector and at least partially raised or bent or curved relative to the flat conductor portion (e.g., FIGS. 50 and 51). The connector portions 128a and conductor portions 128b may comprise any suitable electrically conductive material.

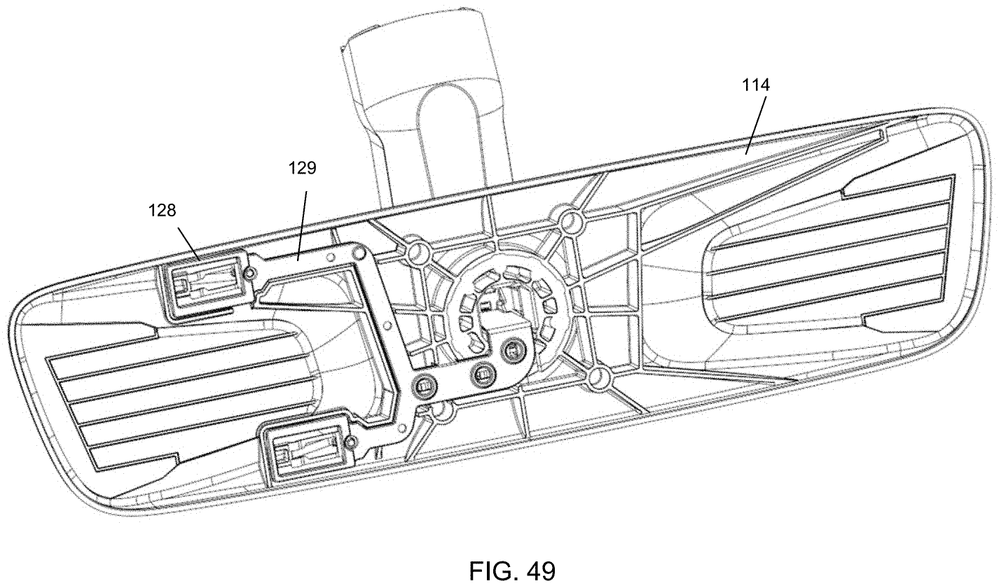

A frame element 129 may receive the electrical connector 128 therein for guiding and supporting the electrical connector 128 within the mirror housing and for snap attaching or connecting to the mirror casing 114 (e.g., FIG. 49). The frame element 129 may include an internal channel with the electrical conductor portions 128b extending along the internal channel, and respective windows or apertures 129a at which the connector portions 128a are exposed for connection to the tabs 126 or connector feature or element 135. The frame element 129 may comprise a non-conductive material, such as a polymeric material, to electrically isolate the electrical connector 128 and avoid forming an electrical connection between the mirror reflective element and the electrical connector 128 at any location other than the tabs 126.

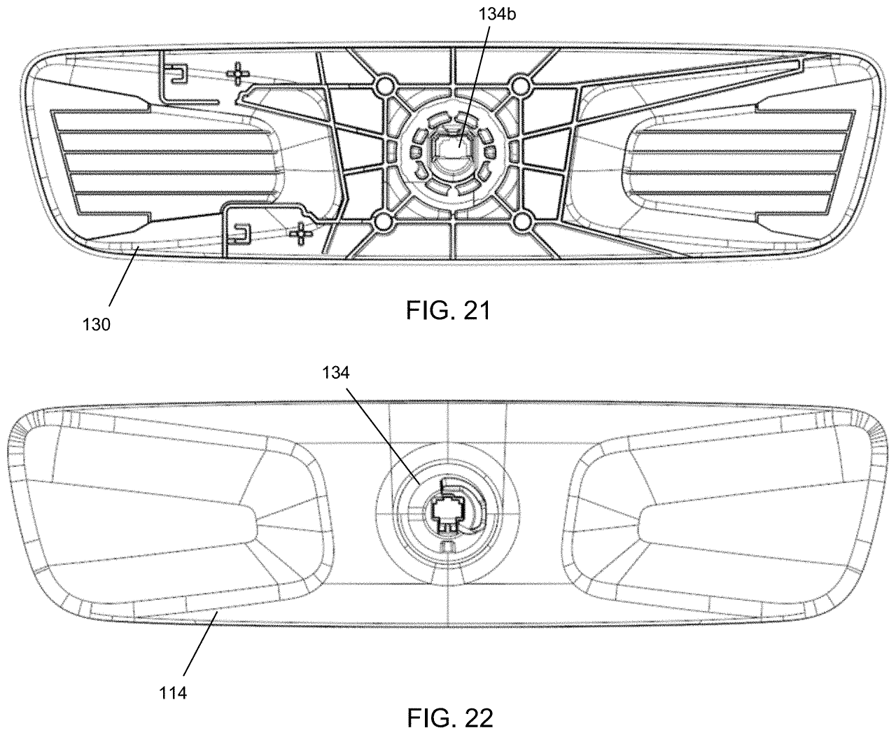

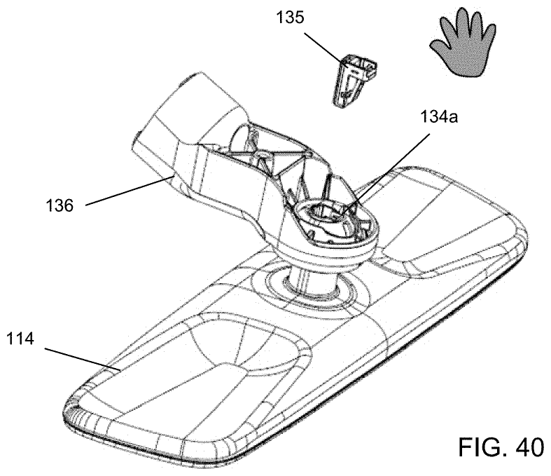

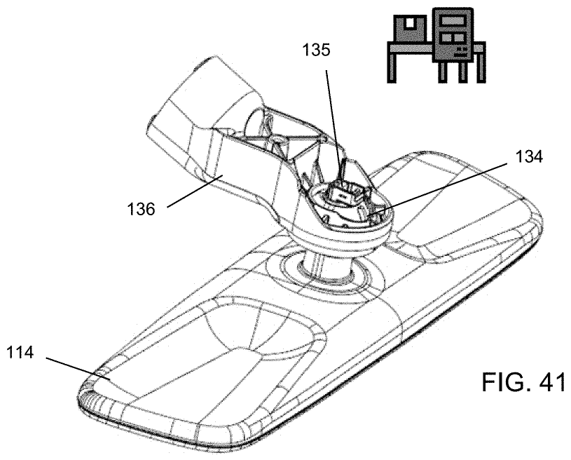

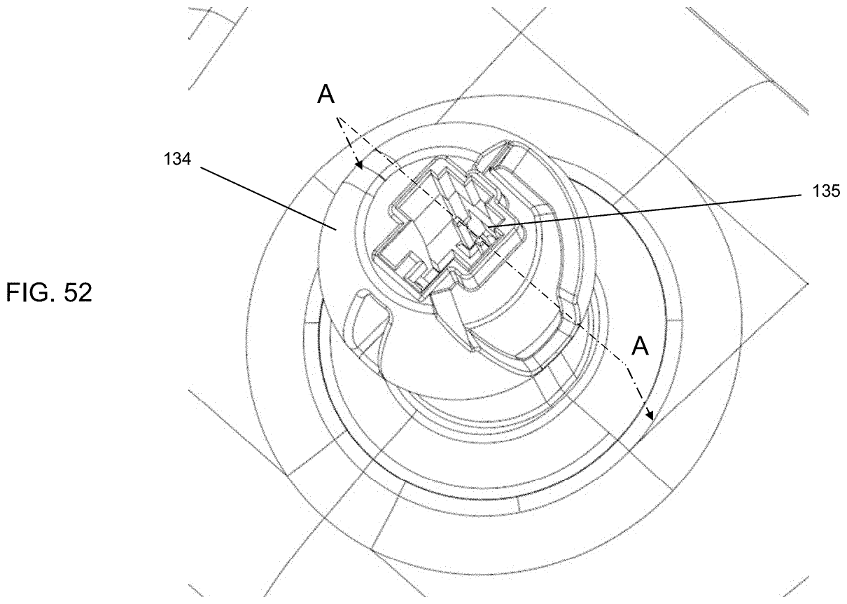

As shown in FIGS. 21-25, the one-piece mirror casing 114 includes an attachment plate portion 130 that is overmolded over the ball member 134. Optionally, the ball member 134 may be integrally formed with the attachment plate portion 130. That is, the ball member 134, that is received in the socket 138 of a mounting base or stay 136 for pivotally mounting the mirror assembly 110 at the interior portion of the vehicle, is integrally formed with or integrated in (via overmolding) the mirror casing 114 to reduce assembly complexity of the mirror assembly. The ball member 134 protrudes or extends from the rear surface of the mirror casing 114 to engage the stay 136 behind the mirror head. A channel or internal passageway 134b (FIGS. 52 and 52A) extends along the ball member 134 between the inner attaching surface of the mirror casing 114 and the connector feature or element 135 so that, with the electrical connector 128 attached at the inner surface of the mirror casing 114, a portion of the electrical connector 128 may pass along the passageway 134b to electrically connect to the connector feature or element 135. The connector feature or element 135 is configured to be received in a connector feature or structure 134a at the end of the passageway through the ball member 134 (see FIGS. 40 and 41) and is configured to electrically connect (such as via a plug and socket connection) with a wire harness connector such that, with the ball member 134 received in the socket 138 of the stay 136 and with the mirror assembly being mounted in a vehicle, the connector feature or element 135 may electrically connect to the vehicle wire harness for electrically connecting the electrochromic reflective element 116 to the vehicle power source.

For example, the housing may be a glass reinforced polyamide material overmolded with a polycarbonate/acrylonitrile butadiene styrene (PC-ABS), such as a N252-AC/PC-ABS overmold. PC-ABS may provide good class A surface characteristics and good adhesion with the foam tape attached to the mirror reflective element. The required structure (e.g., structure 134a) for passing through the electrical connector 128 and connecting to the connector feature or element 135 may be provided in the ball stem area. The one piece design of the ball member and mirror casing may provide the required structure, adhesive qualities, style, and assembly simplicity.

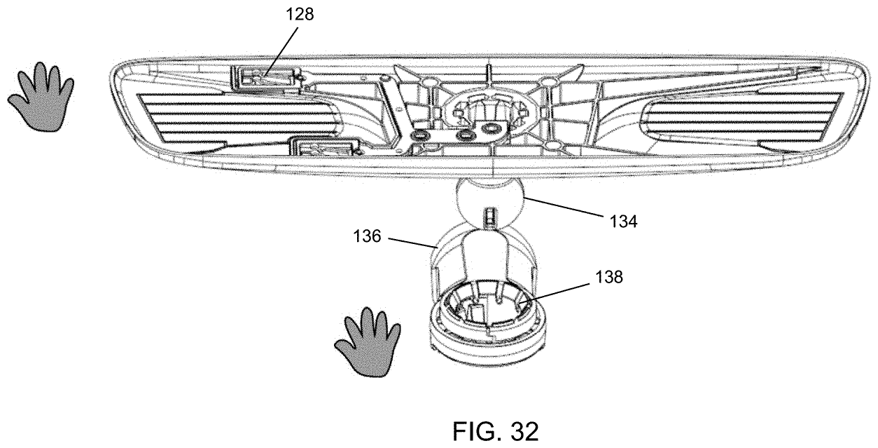

As shown in FIGS. 32-34, the ball member 134, when the mirror assembly 110 is installed at the interior portion of the vehicle, is received in the socket 138 of the stay member 136 and the stay member 136 includes an aperture 136a at a rear of the socket 138 so that the connector feature or element 135 may be connected to the vehicle wire harness and connection may be maintained as the ball member 134 pivots within the socket 136 (FIGS. 26-28 and 53-57F). The stay 136 may comprise any suitable material, such as N2200 G53 (25 percent glass filled polymer (POM)), for structural rigidity. Unfilled POM may be used for the socket/ball pivot area, but it is difficult to achieve required rigidity with unfilled POM. Optionally, manufacturing of the stay may include a two-shot design with unfilled POM in the socket area and glass filled POM for the rest of the window mount. Optionally, the tri-lobe spring clip mounting features and button contacts 146 (i.e., the structure that receives the spring clip) may be updated according to connection features of a windshield mounting button at which the stay is attached to mount the stay and mirror assembly at the interior portion or surface of the vehicle.

Optionally, and as shown in FIG. 29, stay cover elements 148 may attach to the stay element 136 or attach to one another around the stay element to provide a desired appearance of the mirror assembly. The cover elements 148 may be installed after the mirror is installed at the interior portion of the vehicle and after the connector feature or element 135 is electrically connected to the vehicle wire harness. For example, one stay cover element 148 may include snap attachment elements for snap attaching to a corresponding stay cover element 148 with the stay 136 received therein. The stay cover elements 148 may be formed from a PC-ABS material.

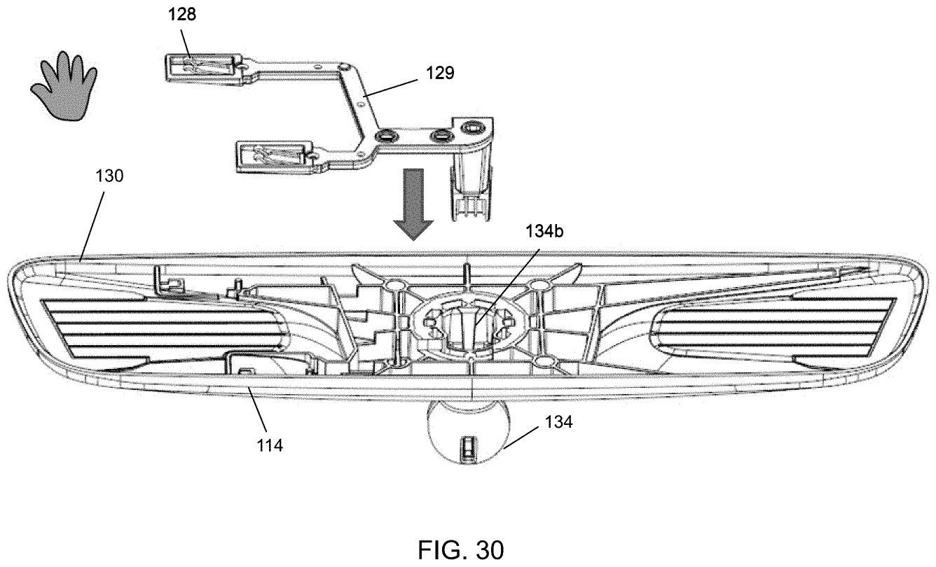

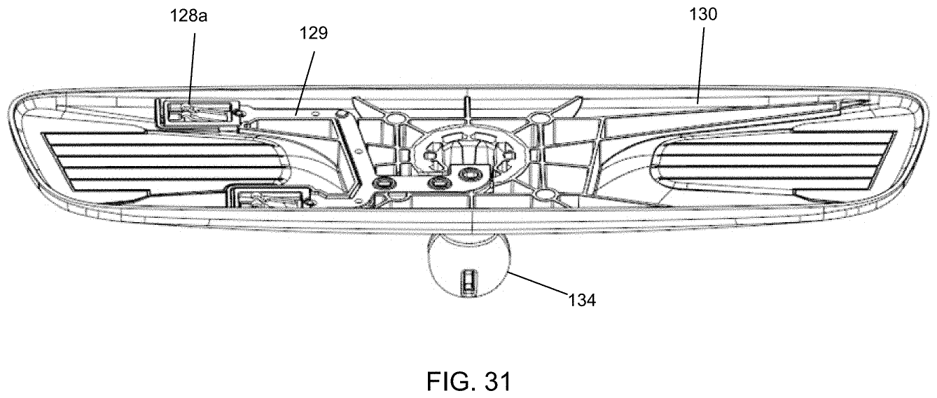

As shown in FIGS. 31-43, the mirror assembly 110, having a one-piece mirror casing 114 with the ball member 134 insert molded therein and with the electrical connector 128 snap attached to the mirror casing 114, is provided for connection to the vehicle wire harness via the connector feature 135 and allows for a simplified assembly and installation process of the mirror assembly 110. With the electrical connector 128 disposed within the frame element 129 (e.g., the plastic frame element may be molded over the metallic connector), the frame element 129 is attached at (such as snap attached) at the inner surface of the mirror casing 114 and a portion of the frame element 129 is received within the channel 134b of the ball member 134 to position the end of the electrical connector 128 at the connector structure 134a (FIGS. 30 and 31). The attachment plate portion 130 of the mirror casing 114 may include a recessed channel or guiding structure for receiving and securing the frame element to the mirror casing and for aligning the connector portions 128a with the position of the tabs 126 and guiding the electrical connector 128 along the passageway 134b of the ball member 134. Thus, with the electrical connector 128 disposed at the inner surface or attachment plate portion 130 of the mirror casing 114, the connector portions 128a of the electrical connector 128 extend at least partially away from the mirror casing 114 for connection to the tabs 126 at the mirror reflective element 116. With the electrical connector 128 disposed at the mirror casing 114, the ball member 134 may be received at the socket 138 of the stay element 136 with the electrical connector 128 exposed at the aperture 136a of the stay element 136, whereby the electrical connector element 135 is received at the connector structure 134a of the ball member for electrically connecting the electrical connector 128 to the vehicle wire harness (FIGS. 32-34).

With the tabs 126 disposed at the mirror reflective element 116 (such as at the second surface of the front glass substrate and the third surface of the rear glass substrate with respective wraparound portions positioned at the fourth or rear surface of the rear glass substrate), an adhesive member or pad or tape 132 is disposed at the mirror reflective element 116 (FIGS. 35-37). The adhesive element 132 includes apertures 132a that, with the adhesive element 132 disposed at the mirror reflective element 116, align with the tabs 126 so that the tabs may, when the mirror reflective element 116 is disposed at the mirror casing 114, electrically connect with the connector portions 128a of the electrical connector 128 through or around the adhesive element 132. Here, the electrical connectors 128 and tabs 126 are disposed on a same side of the mirror reflective element 116 along a peripheral region of the mirror reflective element, but the electrical connectors, tabs, and apertures through the adhesive element may be disposed at any suitable position along the rear surface of the mirror reflective element.

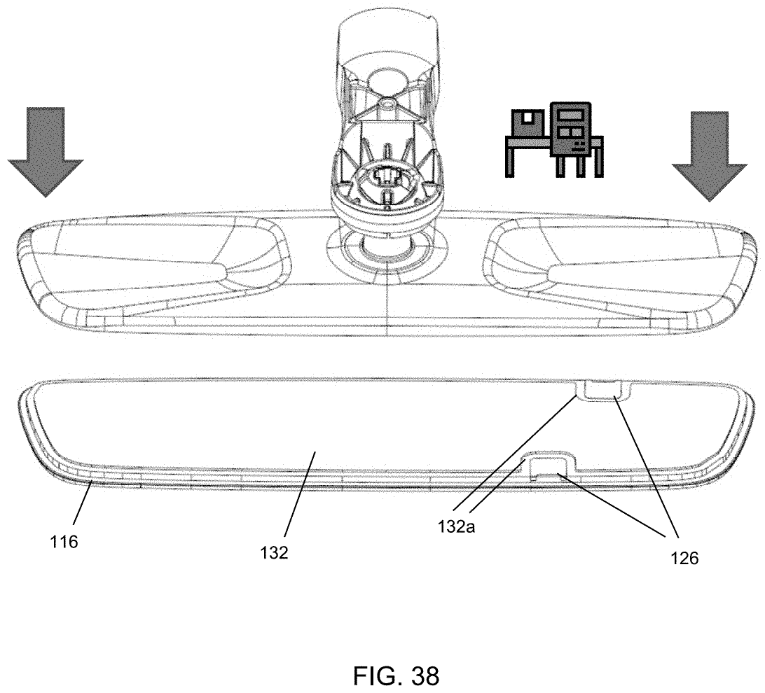

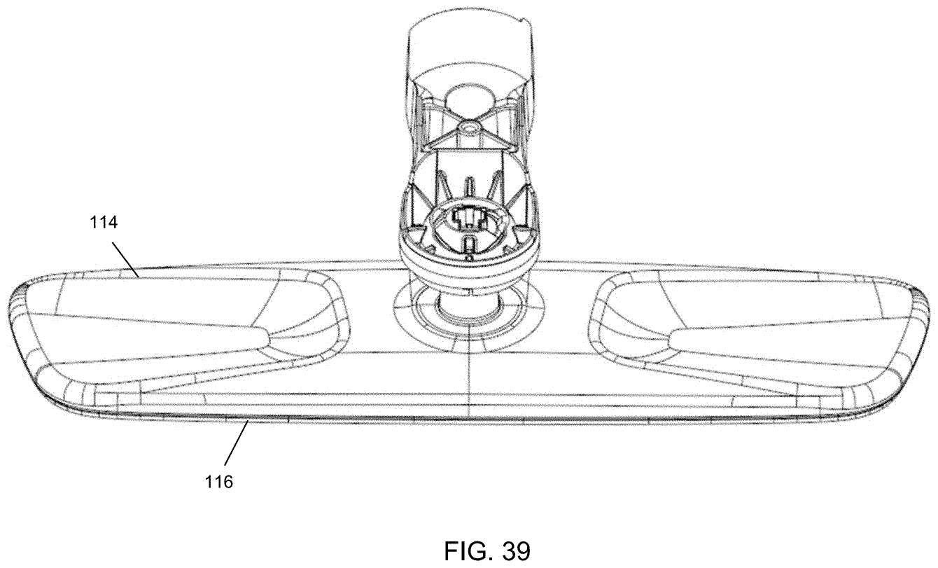

With the adhesive element 132 disposed at the mirror reflective element 116, the mirror reflective element is received at the mirror casing 114 with the adhesive element 132 disposed between the mirror reflective element 116 and the attachment plate portion 130 of the mirror casing 114 to adhere the mirror reflective element 116 thereat (FIGS. 38 and 39). As the mirror reflective element 116 is pressed into engagement with the mirror casing 114, the tabs 126 engage the connector portions 128a of the electrical connector 128 and the connector portions 128a flex to accommodate the mirror reflective element 116 (FIGS. 50 and 51). Thus, when the mirror reflective element is disposed at the mirror casing and the mirror reflective element is pressed into engagement with the mirror casing, the mirror reflective element or tabs deflect the connector portions 128a to bias the connector portions 128a toward engagement with the tabs 126. The spring fingers of the connector portions 128a are configured to flex in response to the force applied by the mirror reflective element when the mirror reflective element is attached at the mirror casing so as to apply a force of, for example, less than 15 Newtons, such as about 12 Newtons, to deflect the fingers of the connector portions 128 upon the EC cell installation.

With the electrical connector 128 disposed along the channel 134b of the ball member 134 and the ball member 134 disposed in the socket 138 of the stay 136, the connector end of the electrical connector 128 is positioned at the connector structure 134a of the passageway of the ball member, whereby the connector feature or element 135 may be disposed at the end of the electrical connector 128 and at the end of the channel 134b (so as to be received at or snap attach to the connector structure 134a) to provide an electrical connector port for connection to a corresponding connector of the vehicle wire harness (FIGS. 40 and 41). The connector feature or element 135 may be electrically connected to the electrical connector 128 after the mirror reflective element 116 is attached at the mirror casing 114. Optionally, the connector feature or element 135 may be integrated with the ball feature 134.

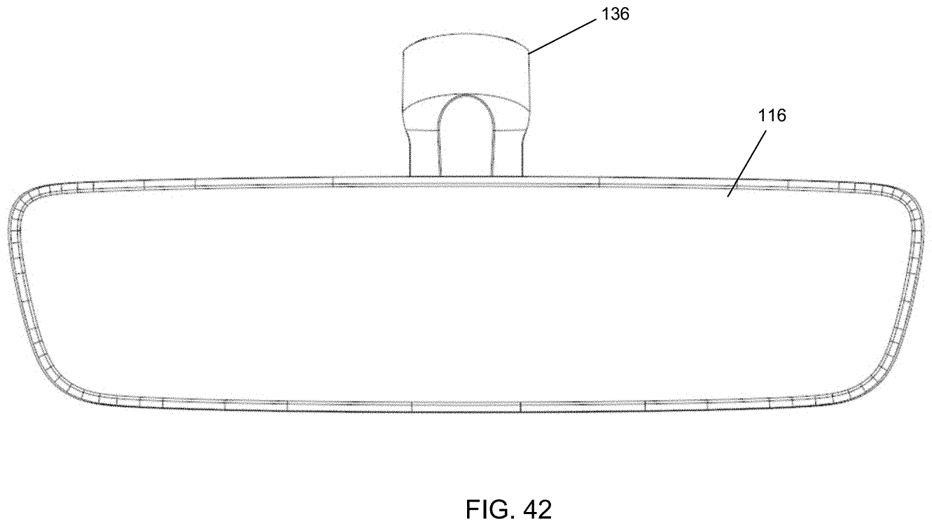

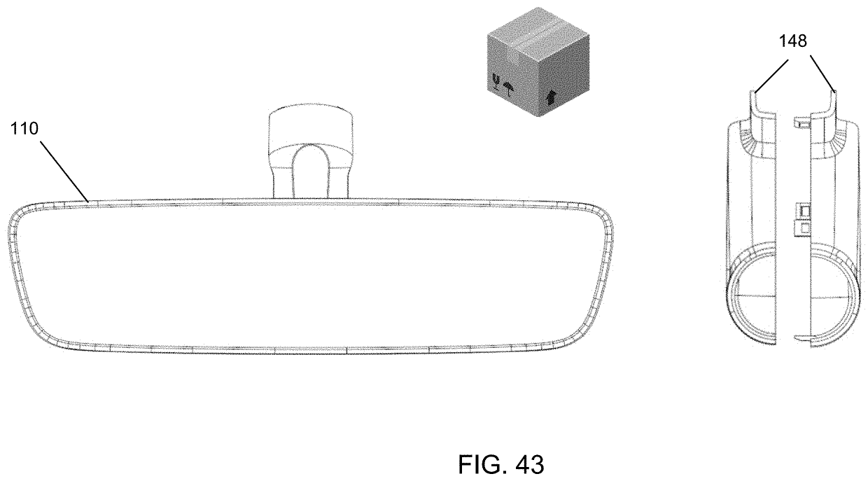

The mirror assembly 110 with mirror reflective element 116 electrically connected to the connector feature or element 135 disposed at the socket 138 of the stay 136 via the electrical connector 128 may be installed at the interior portion of the vehicle, and with the mirror assembly installed at the vehicle, the stay cover elements 148 may be attached to and/or around the stay 136 (FIGS. 42 and 43).

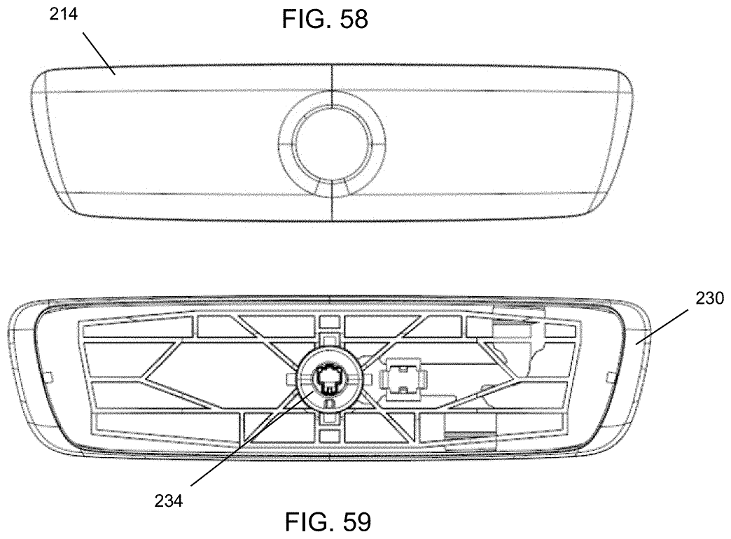

Optionally, and as shown in FIGS. 58-61, the mirror head 212 may include the attachment plate 230 with integrated ball member 234 and a housing cap or mirror casing 214 that is fastened to a rear surface or side of the attachment plate 230 (opposite the side receiving the mirror reflective element). For example, the housing cap 214 may be fastened or snap attached to the attachment plate 230 via clips of the housing cap 214 attaching to respective receivers at the attachment plate 230. The attachment plate 230 may include the integrated ball member or ballstud and connector interface and an integrated bezel circumscribing the outer perimeter of the mirror reflective element and providing a smooth or curved transition between the mirror head 212 and mirror reflective element. The housing cap or mirror casing may provide a cosmetic exterior (e.g., painted, textured, or the like) and may be formed from plastic or sheet metal.

Thus, the mirror assembly with the one-piece mirror casing and snap attaching electrical connector may provide a thinner or lower profile and more cost effective design with improved assembly simplicity. That is, the housing construction, instead of having a stamped sheet metal cap over an adapter plate, comprises a one-piece overmolded ball stud and housing, with the electrical connection to the EC cell being accomplished by an integrated leadframe that snaps into the housing and is accessible at the rear of the housing/ball stud to connect to a vehicle-side wire harness connector. The simplified construction and assembly process of the mirror assembly allows for increased and enhanced automation in the assembly process.

Optionally, the mirror assembly may have its dimming control be responsive to image data captured by a rearward viewing camera of the vehicle (such as a rear backup camera of the vehicle), such as by utilizing aspects of the systems described in U.S. Pat. Nos. 10,967,796 and/or 10,948,798, which are hereby incorporated herein by reference in their entireties. In accordance with such systems, the rear backup camera may include processing capabilities or the processor may be part of a backup assist system or the like, where the processor is operable to process image data captured by the rear camera to determine luminance and glare in the captured image data (such as via processing the internal registers to the camera, which contain luminance data for each location or for configurable locations). Responsive to determination of glare (via low-level processing of luminance data), the system may control the EC cell of the interior rearview mirror.

Optionally, aspects of the present disclosure may be configured to provide electrical connectivity to other electronic components of the interior rearview mirror assembly 10. For example, the interior rearview mirror assembly may comprise a dual-mode interior rearview video mirror that can switch from a traditional reflection mode to a live-video display mode, such as is by utilizing aspects of the mirror assemblies and systems described in U.S. Pat. Nos. 10,442,360; 10,421,404; 10,166,924 and/or 10,046,706, and/or U.S. Publication Nos. US-2021-0245662; US-2021-0162926; US-2021-0155167; US-2020-0377022; US-2019-0258131; US-2019-0146297; US-2019-0118717 and/or US-2017-0355312, which are all hereby incorporated herein by reference in their entireties. The video display screen of the video mirror, when the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like, such as by utilizing aspects of the display systems described in U.S. Publication No. US-2021-0245662, which is hereby incorporated herein by reference in its entirety. In such embodiments, electrical connection between the ECU and mirror assembly for providing the video images to display at the video mirror may be made in a similar manner as described above to provide a slim or reduced thickness video mirror assembly.

The mirror casing may include a bezel portion that circumscribes a perimeter region of the front surface of the reflective element, or the perimeter region of the front surface of the reflective element may be exposed (such as by utilizing aspects of the mirror reflective elements described in U.S. Pat. Nos. 9,827,913; 9,598,016; 9,346,403; 8,508,831 and/or 8,730,553, which are hereby incorporated herein by reference in their entireties).

The reflective element and mirror casing are adjustable relative to a base portion or mounting assembly to adjust the driver's rearward field of view when the mirror assembly is normally mounted at or in the vehicle. The ball member and socket and/or stay described above may utilize aspects of the pivot mounting assemblies described in such as a pivot mounting assembly of U.S. Pat. Nos. 6,318,870; 6,593,565; 6,690,268; 6,540,193; 4,936,533; 5,820,097; 5,100,095; 7,249,860; 6,877,709; 6,329,925; 7,289,037; 7,249,860 and/or 6,483,438, which are hereby incorporated herein by reference in their entireties.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, (and with electrochromic mirrors of such construction commercially available from the assignee of this application under the trade name INFINITY™ mirror).

As discussed above, the mirror assembly may comprise an electro-optic or electrochromic mirror assembly that includes an electro-optic or electrochromic reflective element. The perimeter edges of the reflective element may be encased or encompassed by the perimeter element or portion of the bezel portion to conceal and contain and envelop the perimeter edges of the substrates and the perimeter seal disposed therebetween. The electrochromic mirror element of the electrochromic mirror assembly may utilize the principles disclosed in U.S. Pat. Nos. 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407 and/or 4,712,879, which are hereby incorporated herein by reference in their entireties.

Optionally, the reflective element may include an opaque or substantially opaque or hiding perimeter layer or coating or band disposed around a perimeter edge region of the front substrate (such as at a perimeter region of the rear or second surface of the front substrate) to conceal or hide or the perimeter seal from viewing by the driver of the vehicle when the mirror assembly is normally mounted in the vehicle. Such a hiding layer or perimeter band may be reflective or not reflective and may utilize aspects of the perimeter bands and mirror assemblies described in U.S. Pat. Nos. 5,066,112; 7,626,749; 7,274,501; 7,184,190; 7,255,451; 8,508,831 and/or 8,730,553, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular interior rearview mirror assembly, the vehicular interior rearview mirror assembly comprising:
a mounting base configured to mount at an interior portion of a vehicle equipped with the vehicular interior rearview mirror assembly, the mounting base comprising a socket;
a mirror head attached at and pivotable about the mounting base, the mirror head comprising a mirror reflective element,
wherein the mirror head comprises a ball member;
wherein the ball member of the mirror head and the socket of the mounting base form a pivot joint;
wherein the mirror reflective element comprises a variable reflectance electro-optic mirror reflective element having (i) a front substrate having a first surface and a second surface and (ii) a rear substrate having a third surface and a fourth surface;
wherein a transparent electrically conductive film is disposed at the second surface of the front substrate and an electrically conductive film is disposed at the third surface of the rear substrate, and wherein an electro-optic medium is disposed between the front substrate and the rear glass substrate and contacts the transparent electrically conductive film at the second surface of the front substrate and the electrically conductive film at the third surface of the rear substrate;
wherein electrically conductive contacts at a rear side of the mirror reflective element are in electrical connection with respective ones of the transparent electrically conductive film at the second surface of the front substrate of the mirror reflective element and the electrically conductive film at the third surface of the rear substrate of the mirror reflective element;
wherein the mirror reflective element is attached at an attachment plate;
wherein the attachment plate comprises electrically conductive elements, and wherein respective connector portions of the electrically conductive elements electrically connect to respective ones of the electrically conductive contacts at the rear side of the mirror reflective element;
wherein electrical connection of the electrically conductive elements to the respective electrically conductive contacts at the rear side of the mirror reflective element is made via the connector portion of each electrically conductive element, as the mirror reflective element is attached at the attachment plate, engaging the respective electrically conductive contact and flexing and being biased toward the respective electrically conductive contact to maintain electrical connection with the electrically conductive contact;
wherein circuitry for controlling dimming of the variable reflectance electro-optic mirror reflective element is disposed remote from the vehicular interior rearview mirror assembly; and
wherein the electrically conductive elements of the attachment plate are electrically connected to a connector of the ball member, and wherein, with the mounting base mounted at the interior portion of the vehicle and the ball member received in the socket of the mounting base, the connector is electrically connected to a wire harness of the vehicle to electrically connect to the circuitry for controlling dimming of the variable reflectance electro-optic mirror reflective element.

2. The vehicular interior rearview mirror assembly of claim 1, wherein the connector portions comprise spring-biased connector portions that are biased into engagement with the electrically conductive contacts at the rear side of the mirror reflective element.

3. The vehicular interior rearview mirror assembly of claim 1, wherein the connector portions each comprise a rounded contact pad that engages the respective electrically conductive contacts at the rear side of the mirror reflective element.

4. The vehicular interior rearview mirror assembly of claim 1, wherein the mirror reflective element is adhesively attached at the attachment plate via an adhesive element that adhesively engages the attachment plate at a first side of the adhesive element and that adhesively engages the mirror reflective element at a second side of the adhesive element opposite the first side.

5. The vehicular interior rearview mirror assembly of claim 4, wherein the adhesive element is disposed between the electrically conductive elements of the attachment plate and the rear side of the mirror reflective element except at positions along the rear side of the mirror reflective element corresponding to the electrically conductive contacts.

6. The vehicular interior rearview mirror assembly of claim 5, wherein the connector portions of the electrically conductive elements protrude through respective apertures in the adhesive element to establish electrical connection with the electrically conductive contacts at the rear side of the mirror reflective element.

7. The vehicular interior rearview mirror assembly of claim 4, wherein the mirror head comprises a mirror casing, and wherein the attachment plate comprises an aperture, and wherein the first side of the adhesive element adhesively engages the mirror casing through the aperture of the attachment plate to attach the mirror reflective element and the attachment plate to the mirror casing.

8. The vehicular interior rearview mirror assembly of claim 4, wherein the adhesive element comprises a foam tape.

9. The vehicular interior rearview mirror assembly of claim 1, wherein the electrically conductive elements are insert molded with the attachment plate.

10. The vehicular interior rearview mirror assembly of claim 1, wherein the ball member is integrally formed with the attachment plate and protrudes through an aperture of a mirror casing of the mirror head to be exposed exterior the mirror head.

11. The vehicular interior rearview mirror assembly of claim 10, wherein electrically conductive terminals in electrical connection to the electrically conductive elements of the attachment plate are routed through the ball member to electrically connect the connector of the ball member and the electrically conductive elements of the attachment plate.

12. The vehicular interior rearview mirror assembly of claim 1, wherein the ball member is integrally formed with a mirror casing of the mirror head.

13. The vehicular interior rearview mirror assembly of claim 1, wherein the mirror head comprises a mirror casing, and wherein an inner side of the mirror casing comprises the attachment plate.

14. The vehicular interior rearview mirror assembly of claim 1, wherein the electrically conductive elements are disposed within and along a frame portion that attaches to the attachment plate.

15. The vehicular interior rearview mirror assembly of claim 14, wherein the frame portion snap attaches to the attachment plate.

16. The vehicular interior rearview mirror assembly of claim 1, wherein the mirror reflective element comprises a variable reflectance electrochromic mirror reflective element.

17. A vehicular interior rearview mirror assembly, the vehicular interior rearview mirror assembly comprising:
a mounting base configured to mount at an interior portion of a vehicle equipped with the vehicular interior rearview mirror assembly, the mounting base comprising a socket;
a mirror head attached at and pivotable about the mounting base, the mirror head comprising a mirror reflective element,
wherein the mirror head comprises a ball member;
wherein the ball member of the mirror head and the socket of the mounting base form a pivot joint;
wherein the mirror reflective element comprises a variable reflectance electro-optic mirror reflective element having (i) a front substrate having a first surface and a second surface and (ii) a rear substrate having a third surface and a fourth surface;
wherein a transparent electrically conductive film is disposed at the second surface of the front substrate and an electrically conductive film is disposed at the third surface of the rear substrate, and wherein an electro-optic medium is disposed between the front substrate and the rear glass substrate and contacts the transparent electrically conductive film at the second surface of the front substrate and the electrically conductive film at the third surface of the rear substrate;
wherein electrically conductive contacts at a rear side of the mirror reflective element are in electrical connection with respective ones of the transparent electrically conductive film at the second surface of the front substrate of the mirror reflective element and the electrically conductive film at the third surface of the rear substrate of the mirror reflective element;
wherein the mirror reflective element is attached at an attachment plate;
wherein the ball member is integrally formed with the attachment plate and protrudes through an aperture of a mirror casing of the mirror head to be exposed exterior the mirror head;
wherein the attachment plate comprises electrically conductive elements, and wherein respective connector portions of the electrically conductive elements electrically connect to respective ones of the electrically conductive contacts at the rear side of the mirror reflective element;
wherein electrical connection of the electrically conductive elements to the respective electrically conductive contacts at the rear side of the mirror reflective element is made via the connector portion of each electrically conductive element, as the mirror reflective element is attached at the attachment plate, engaging the respective electrically conductive contact and flexing and being biased toward the respective electrically conductive contact to maintain electrical connection with the electrically conductive contact;
wherein the connector portions comprise spring-biased connector portions that are biased into engagement with the electrically conductive contacts at the rear side of the mirror reflective element;
wherein circuitry for controlling dimming of the variable reflectance electro-optic mirror reflective element is disposed remote from the vehicular interior rearview mirror assembly; and
wherein the electrically conductive elements of the attachment plate are electrically connected to a connector of the ball member, and wherein, with the mounting base mounted at the interior portion of the vehicle and the ball member received in the socket of the mounting base, the connector is electrically connected to a wire harness of the vehicle to electrically connect to the circuitry for controlling dimming of the variable reflectance electro-optic mirror reflective element.

18. The vehicular interior rearview mirror assembly of claim 17, wherein the connector portions each comprise a rounded contact pad that engages the respective electrically conductive contacts at the rear side of the mirror reflective element.

19. The vehicular interior rearview mirror assembly of claim 17, wherein the mirror reflective element is adhesively attached at the attachment plate via an adhesive element that adhesively engages the attachment plate at a first side of the adhesive element and that adhesively engages the mirror reflective element at a second side of the adhesive element opposite the first side.

20. The vehicular interior rearview mirror assembly of claim 19, wherein the connector portions of the electrically conductive elements protrude through respective apertures in the adhesive element to establish electrical connection with the electrically conductive contacts at the rear side of the mirror reflective element.

21. The vehicular interior rearview mirror assembly of claim 19, wherein the attachment plate comprises an aperture, and wherein the first side of the adhesive element adhesively engages the mirror casing through the aperture of the attachment plate to attach the mirror reflective element and the attachment plate to the mirror casing.

22. The vehicular interior rearview mirror assembly of claim 17, wherein electrically conductive terminals in electrical connection to the electrically conductive elements of the attachment plate are routed through the ball member to electrically connect the connector of the ball member and the electrically conductive elements of the attachment plate.

23. A vehicular interior rearview mirror assembly, the vehicular interior rearview mirror assembly comprising:
a mounting base configured to mount at an interior portion of a vehicle equipped with the vehicular interior rearview mirror assembly, the mounting base comprising a socket;
a mirror head attached at and pivotable about the mounting base, the mirror head comprising a mirror casing and a mirror reflective element,
wherein the mirror head comprises a ball member, and wherein the ball member is integrally formed with the mirror casing of the mirror head;
wherein the ball member of the mirror head and the socket of the mounting base form a pivot joint;
wherein the mirror reflective element comprises a variable reflectance electro-optic mirror reflective element having (i) a front substrate having a first surface and a second surface and (ii) a rear substrate having a third surface and a fourth surface;
wherein a transparent electrically conductive film is disposed at the second surface of the front substrate and an electrically conductive film is disposed at the third surface of the rear substrate, and wherein an electro-optic medium is disposed between the front substrate and the rear glass substrate and contacts the transparent electrically conductive film at the second surface of the front substrate and the electrically conductive film at the third surface of the rear substrate;
wherein electrically conductive contacts at a rear side of the mirror reflective element are in electrical connection with respective ones of the transparent electrically conductive film at the second surface of the front substrate of the mirror reflective element and the electrically conductive film at the third surface of the rear substrate of the mirror reflective element;
wherein the mirror reflective element is attached at an inner side of the mirror casing;
wherein the inner side of the mirror casing comprises electrically conductive elements, and wherein respective connector portions of the electrically conductive elements electrically connect to respective ones of the electrically conductive contacts at the rear side of the mirror reflective element;
wherein electrical connection of the electrically conductive elements to the respective electrically conductive contacts at the rear side of the mirror reflective element is made via the connector portion of each electrically conductive element, as the mirror reflective element is attached at the inner side of the mirror casing, engaging the respective electrically conductive contact and flexing and being biased toward the respective electrically conductive contact to maintain electrical connection with the electrically conductive contact;
wherein circuitry for controlling dimming of the variable reflectance electro-optic mirror reflective element is disposed remote from the vehicular interior rearview mirror assembly;
wherein electrically conductive terminals in electrical connection to the electrically conductive elements of the inner side of the mirror casing are routed through the ball member to electrically connect a connector of the ball member and the electrically conductive elements of the inner side of the mirror casing; and
wherein, with the mounting base mounted at the interior portion of the vehicle and the ball member received in the socket of the mounting base, the connector of the ball member is electrically connected to a wire harness of the vehicle to electrically connect to the circuitry for controlling dimming of the variable reflectance electro-optic mirror reflective element.

24. The vehicular interior rearview mirror assembly of claim 23, wherein the connector portions comprise spring-biased connector portions that are biased into engagement with the electrically conductive contacts at the rear side of the mirror reflective element.

25. The vehicular interior rearview mirror assembly of claim 23, wherein the connector portions each comprise a rounded contact pad that engages the respective electrically conductive contacts at the rear side of the mirror reflective element.

26. The vehicular interior rearview mirror assembly of claim 23, wherein the mirror reflective element is adhesively attached at the inner side of the mirror casing via an adhesive element that adhesively engages the inner side of the mirror casing at a first side of the adhesive element and that adhesively engages the mirror reflective element at a second side of the adhesive element opposite the first side.

27. The vehicular interior rearview mirror assembly of claim 26, wherein the adhesive element is disposed between the electrically conductive elements of the inner side of the mirror casing and the rear side of the mirror reflective element except at positions along the rear side of the mirror reflective element corresponding to the electrically conductive contacts.

28. The vehicular interior rearview mirror assembly of claim 27, wherein the connector portions of the electrically conductive elements protrude through respective apertures in the adhesive element to establish electrical connection with the electrically conductive contacts at the rear side of the mirror reflective element.

29. The vehicular interior rearview mirror assembly of claim 23, wherein the electrically conductive elements are insert molded with the inner side of the mirror casing.
